(19) United States
(12) Patent Application Publication
(10) Pub. No.: US 2006/0182893 A1
(43) Pub. Date: Aug. 17, 2006

(54) Curtain coating method

(76) Inventors: Robert J. Fermin, La Verne, CA (US); Alexander A. Jansen, Zoetermeer (NL); Chunhwa Wang, Diamond Bar, CA (US)

Correspondence Address: Cynthia S. Murphy;Renner, Otto, Boisselle & Sklar, LLP, Nineteenth Floor, 1621 Euclid Avenue, Cleveland, OH, 44115, US

(21) Appl. No.: 11/402,443

(22) Filed: Apr. 12, 2006

Related U.S. Application Data
(63) Continuation of application No. PCT/US05/31779, filed on Sep. 8, 2005.
(60) Provisional application No. 60/608,213, filed on Sep. 9, 2004.

(51) Int. Cl. B05D 1/30; B05C 3/02

(52) U.S. Cl. 427/420; 118/410

(57) ABSTRACT

A curtain coating method comprising the steps of conveying a substrate (12) in a downstream direction (D) through an impingement zone (14), and impinging the substrate (12) with a free-falling curtain (16) in the impingement zone (14) at an acute angle (θ). The force ratio (Re) of the curtain (16) at the impingement zone (16) is greater than about 5.25 (e.g., greater than about 5.50, about 6.00, about 6.50, about 7.00, about 7.50, and/or about 8.00) whereby the method may be used with a curtain (14) having a high mass flow rate (Q*ρ) and/or a low viscosity (η).

### RELATED APPLICATIONS

This application is a continuation under 35 U.S.C. §120 of International Application No. PCT/US2005/031779 which claims priority to U.S. Provisional Application No. 60/608,213. The entire disclosure of this international application and the entire disclosure of this provisional application are hereby incorporated by reference.

### FIELD OF THE INVENTION

The present invention relates generally, as indicated, to a curtain coating method and, more particularly, to a method wherein a moving substrate is impinged by a free-falling curtain of a liquid coating composition as the substrate passes through an impingement zone.

### BACKGROUND OF THE INVENTION

A curtain coating method generally comprises impinging a moving substrate with a free-falling curtain of a liquid coating composition as the substrate passes through an impingement zone. A customer will typically specify a certain substrate (e.g., paper or plastic film), a particular coating composition (e.g., adhesive coating) and a desired coating weight (ctwt). The selected coating composition will have a density (ρ), a percent solids (%), and a viscosity (η). For example, an adhesive coating composition will have a density (ρ) between about 900 kg/m³ and about 1100 kg/m³ and a viscosity (η) between about 0.040 Pa*s and about 0.160 Pa*s. If the liquid coating composition were perfectly applied, the coating would have a predetermined uniform thickness (t_{∞}) equal to the coating weight (ctwt) divided by the percent of solids (%) and the density (ρ) of the liquid coating composition.

The substrate moves through the impingement zone at a certain substrate velocity (U) and the curtain contacts the substrate at an impingement velocity (V). A conveyor controls the substrate speed and generally allows this speed to be set between at least about 300 m/min and about 1000 m/min. The impingement velocity (V) controlled by gravitational acceleration (g) and can be calculated from the curtain's initial velocity (V₀) at die-lip-detachment and its height (h) from die-lip-detachment to the impingement zone. (i.e., V=V₀+(2gh)^{1/2}). Thus, for example, if a curtain has a height (h) of about 15 cm and an initial velocity (V₀) of about zero, the impingement velocity will be about 1.72 m/s.

The curtain has a certain volumetric flow rate per unit width (Q) at the impingement zone. The volumetric flow rate (Q) should equal the product of the substrate velocity (U) and the predetermined uniform coating thickness (t_{∞}). As was noted above, a customer will specify a particular coating composition (and thus a particular density (ρ) and a particular percent solids (%)) and a desired coating weight (ctwt), and thus essentially specifies a predetermined uniform coating thickness (t_{∞}). Accordingly, for a given coating composition and a given coating weight (ctwt), a reduction in the volumetric flow rate (Q) results in a corresponding reduction of substrate velocity (U).

A curtain's flow characteristics at the impingement zone can be expressed in terms of the ratio of its inertia force (ρ*Q) to its viscous force (η), that is its Reynolds number (Re). Thus, for a particular customer-specified coating composition, the force ratio (Re) can be raised and lowered by increasing and decreasing, respectively, the volumetric flow rate (Q).

A curtain coating method can only be successfully performed upon the correct correlation of curtain coating parameters, including substrate velocity (U), impingement velocity (V), and force ratio (Re). If a curtain coating method is successfully performed, the substrate will be provided with an extremely consistent and precise coating over thousands of meters of substrate length. Specifically, for example, the coating will have a thickness (t_{w}) that varies very little (e.g., less than 2%, less than 1.5%, less than 1.0% and/or less than 0.5%) from the predetermined uniform coating thickness (t_{∞}) over the width (w) of the coating.

In the past, curtain coating has not been successful at relatively high force ratios (e.g., greater than 5.25). This problem has been solved or, perhaps more accurately, avoided, by decreasing the volumetric flow rate (Q) to thereby reduce the force ratio (Re). As was noted above, for a given customer-specified coating weight (ctwt), a relatively low volumetric flow rate (Q) requires a relatively low substrate velocity (U).

The substrate velocity (U) is the overall production speed for the curtain coating process. The higher the substrate velocity (U), the more efficient the manufacturing process. Accordingly, from an economic point of view, a high substrate velocity (U) is preferred as it best maximizes the productivity of capital-investment curtain coating equipment. However, the inability to successfully curtain coat at high force ratios (Re) has resulted in the industry settling for relatively low volumetric flow rates (Q) and thus relatively low substrate velocities (U).

### SUMMARY OF THE INVENTION

The present invention provides a method for successfully curtain coating a substrate when the impinging curtain has a high force ratio (Re). Thus, with the present invention, high volumetric flow rates (Q) are feasible, thereby making high substrate velocities (U) possible, and thereby best maximizing the productivity of capital-investment curtain coating equipment.

More particularly, the present invention provides a curtain coating method to form a coating on a substrate of a desired coating weight (ctwt). The method comprises the steps of conveying the substrate in a downstream direction (D) through an impingement zone, and impinging the substrate with a free-falling curtain in the impingement zone. The force ratio (Re) of the curtain in the impingement zone reflects a relatively high inertia force and/or a relatively low viscous force. Specifically, the force ratio (Re) is greater than about 5.25, greater than about 5.5, greater than about 6.0, greater than about 6.5, greater than about 7.0, greater than about 7.5, and/or greater than about 8.0.

The curtain impinges the substrate at an impingement angle (θ) that is less than 90°. For example, the impingement angle (θ) can be between about 70° and about 50°, between about 65° and about 55°, not greater than about 65°, not greater than about 60°, and/or not greater than about 55°. If the substrate is conveyed around a back-up roller, this impingement orientation can be accomplished by the impingement zone being offset from the top-dead-center of the back-up roller. If the substrate is conveyed between two rollers, this impingement orientation can be accomplished by the rollers being vertically offset.

The substrate is conveyed through the impingement zone at a substrate velocity (U) and the curtain impinges the substrate at an impingement velocity (V). Because the impingement angle (θ) is less than 90°, the substrate velocity (U) has a horizontal component (Uₓ) and a vertical component (U_{y}). Also, the impingement velocity (V) has a component (V_{⊥}) perpendicular to the substrate velocity (U) and a component (V_{∥}) parallel to the substrate velocity (U).

The present invention includes the appreciation that the relevant speed ratio (SP) should be equal to the ratio of the substrate velocity (U) to the perpendicular impingement component (V_{⊥}). This speed ratio (SP) properly represents the velocity shift at the impingement zone as the parallel impingement component (V_{∥}) does not necessitate any velocity shift and/or as only the perpendicular impingement component (V_{⊥}) requires a velocity shift.

The present invention also includes the appreciation that vertical component (U_{y}) of the substrate velocity (U) is significant in that it provides downward momentum to the liquid coating composition as it impinges the substrate. This “push” in the impingement zone is believed to prevent the heel formation and/or air entrapment which would otherwise occur at high force ratios. In a curtain coating method according to the present invention, the speed ratio (SP) is greater than about 7.0 and less than about 12.0. More specifically, when the force ratio (Re) is less than about 6, the speed ratio (SP) is between about 7.5 and about 9.5 (corresponding to a substrate speed (U) in a range of about 700 m/min to about 800 m/min when the impingement velocity (V) is about 1.72 m/s). When the force ratio (Re) is between about 6 and 7, the speed ratio (SP) is between about 8.6 and about 11.9 (corresponding to a substrate velocity (U) range of about 800 m/min to about 1000 m/min when the impingement velocity (V) is about 1.72 m/s). When the force ratio (Re) is between 7 and 8 and the speed ratio (SP) is between about 9.6 and about 11.9 (corresponding to a substrate velocity (U) range of about 900 m/min to about 1000 m/min when the impingement velocity is about 1.72 m/s). When the force ratio (Re) is greater than 8, the speed ratio (SP) is greater than 10 (corresponding to a substrate speed (U) of at least about 1000 m/min when the impingement speed (V) is about 1.72 m/s).

For an adhesive coating composition (e.g. a coating composition having a density (ρ) between about 900 kg/m³ and about 1100 kg/m³ and having a viscosity (η) between about 0.040 Pa s and about 0.160 Pa s) volumetric flow rates (Q) in excess of 0.000900 m³/s*m are possible. Specifically, for example, volumetric flow rates (Q) of about 0.000189 m³/(s*m) to about 0.00107 m³/(s*m) are possible (when the force ratio (Re) is from about 5.2 to about 6.0 and/or the speed ratio (SP) is between about 7.5 and about 9.5); volumetric flow rates (Q) of about 0.000218 m³/(s*m) to about 0.00124 m³/(s*m) are possible (when the force ratio (Re) is between about 6.0 and about 7.0 and/or the speed ratio (SP) is between about 8.6 and about 11.9); volumetric flow rates (Q) of about 0.000255 m³/(s*m) to about 0.00142 m³/(s*m) are possible (when the force ratio (Re) is between about 7.0 and about 8.0 and/or the speed ratio (SP) is between about 9.6 and 11.9); and volumetric flow rates (Q) as high as 0.0147 m³/(s*m) are possible (when the force ratio (Re) is above about 8.0 and/or the speed ratio (SP) is between about 10.7 and 11.9).

For a release or other low viscosity composition (e.g. a coating composition having a density (ρ) between about 900 kg/m³ and about 1100 kg/m³ and having a viscosity (η) between about 0.005 Pa s and about 0.015 Pa s) volumetric flow rates (Q) in excess of 0.000090 m³/s*m are possible. Specifically, for example, volumetric flow rates (Q) from about 0.000024 m³/(s*m) to about 0.000100 m³/(s*m) are possible (when the force ratio (Re) is from about 5.2 to about 6.0 and/or when the speed ratio (SP) is between about 7.5 and about 9.5); volumetric flow rates (Q) from about 0.000027 m³/(s*m) to about 0.000117 m³/(s*m) are possible (when the force ratio (Re) is between about 6 and about 7 and/or when the speed ratio (SP) is between about 8.6 and about 11.9); volumetric flow rates (Q) of about 0.000032 m³/(s*m) to about 0.000133 m³/(s*m) are possible (when the force ratio (Re) is between about 7 and about 8 and/or the speed ratio (SP) is between about 9.6 and about 11.9); and volumetric flow rates (Q) above 0.000136 m³/(s*m) are possible (when the force ratio (Re) is above 8 and/or the speed ratio (SP) is between about 10.7 and about 11.9).

These and other features of the invention are fully described and particularly pointed out in the claims. The following description and drawings set forth in detail certain illustrative embodiments of the invention which are indicative of but a few of the various ways in which the principles of the invention may be employed.

### DRAWINGS

FIGS. 1A and 1B are schematic views of curtain coating methods wherein the impingement angle (θ) is approximately equal to 90°.

FIG. 2 is a close-up schematic view of a successfully curtain-coated product.

FIGS. 3A and 3B are schematic views of the substrate velocity (U) vector and the impingement velocity (V) vector at the impingement zone in the curtain coating methods shown in FIGS. 1A and 1B, respectively.

FIGS. 4A and 4B are schematic views of curtain coating methods wherein the impingement angle (θ) is less than 90°.

FIGS. 5A and 5B are schematic views of the substrate velocity (U) vector and the impingement velocity (V) vector at the impingement zone in the curtain coating methods shown in FIGS. 5A and 5B, respectively.

FIGS. 6A and 6B are front schematic views of edge guides for the curtain coating systems shown in FIGS. 1A-1B and FIG. 4A-4B, respectively.

FIG. 7 is a schematic view of a vacuum assembly modified to accommodate the curtain coating system shown in FIG. 4A.

FIGS. 8A and 8B are side schematic views of die lips for the curtain coating systems shown in FIGS. 1A-1B and FIG. 4A-4B, respectively.

### TABLES

Table 1 is a compilation of raw data collected during curtain coating runs at various substrate velocities (U) and impingement angles (θ), the data being sorted by run number.

Table 2A is a compilation of the speed ratios (SP) and the force ratios (Re) during curtain coating runs when the impingement angle (θ) was equal to 90°, the data being sorted by speed ratios (SP).

Table 2B is a compilation of the speed ratios (SP) and the force ratios (Re) during curtain coating runs when the impingement angle (θ) was equal to 90°, the data being sorted by force ratios (Re).

Table 3A is a compilation of the speed ratios (SP) and the force ratios (Re) during curtain coating runs when the impingement angle (θ) was equal to 65°, the data being sorted by speed ratios (SP).

Table 3B is a compilation of the speed ratios (SP) and the force ratios (Re) during curtain coating runs when the impingement angle (θ) was equal to 65°, the data being sorted by force ratios (Re).

Table 4A is a compilation of the speed ratios (SP) and the force ratios (Re) during curtain coating runs when the impingement angle (θ) was equal to 60°, the data being sorted by speed ratios (SP).

Table 4B is a compilation of the speed ratios (SP) and the force ratios (Re) during curtain coating runs when the impingement angle (θ) was equal to 60°, the data being sorted by force ratios (Re).

Table 5A is a compilation of the speed ratios (SP) and the force ratios (Re) during curtain coating runs when the impingement angle (θ) was equal to 55°, the data being sorted by speed ratios (SP).

Table 5B is a compilation of the speed ratios (SP) and the force ratios (Re) during curtain coating runs when the impingement angle (θ) was equal to 55°, the data being sorted by force ratios (Re).

Table 6A is a compilation of the speed ratios (SP) and the force ratios (Re) during curtain coating runs when the impingement angle (θ) was equal to 90°, 65°, 60°, and 55°, the data being sorted by speed ratios (SP).

Table 6B is a compilation of the speed ratios (SP) and the force ratios (Re) during curtain coating runs when the impingement angle (θ) was equal to 90°, 65°, 60°, and 55°, the data being sorted by force ratios (Re).

### GRAPHS

Graph 1A is a plot of the relationship between the speed ratio (SP) and the force ratio (Re) when the impingement angle (θ) is equal to 90°.

Graph 1B is a plot of the relationship between the substrate velocity (U) and the force ratio (Re) when the impingement angle (θ) is equal to 90°.

Graph 2A is a plot of the relationship between the speed ratio (SP) and the force ratio (Re) when the impingement angle (θ) is equal to 65°.

Graph 2B is a plot of the relationship between the substrate velocity (U) and force ratio (Re) when the impingement angle (θ) is equal to 65°.

Graph 3A is a plot of the relationship between the speed ratio (SP) and the force ratio (Re) when the impingement angle (θ) is equal to 60°.

Graph 3B is a plot of the relationship between the substrate velocity (U) and the force ratio (Re) when the impingement angle (θ) is equal to 60°.

Graph 4A is a plot of the relationship between the speed ratio (SP) and the force ratio (Re) when the impingement angle (θ) is equal to 55°.

Graph 4B is a plot of the relationship between the substrate velocity (U) and the force ratio (Re) when the impingement angle (θ) is equal to 55°.

### DETAILED DESCRIPTION

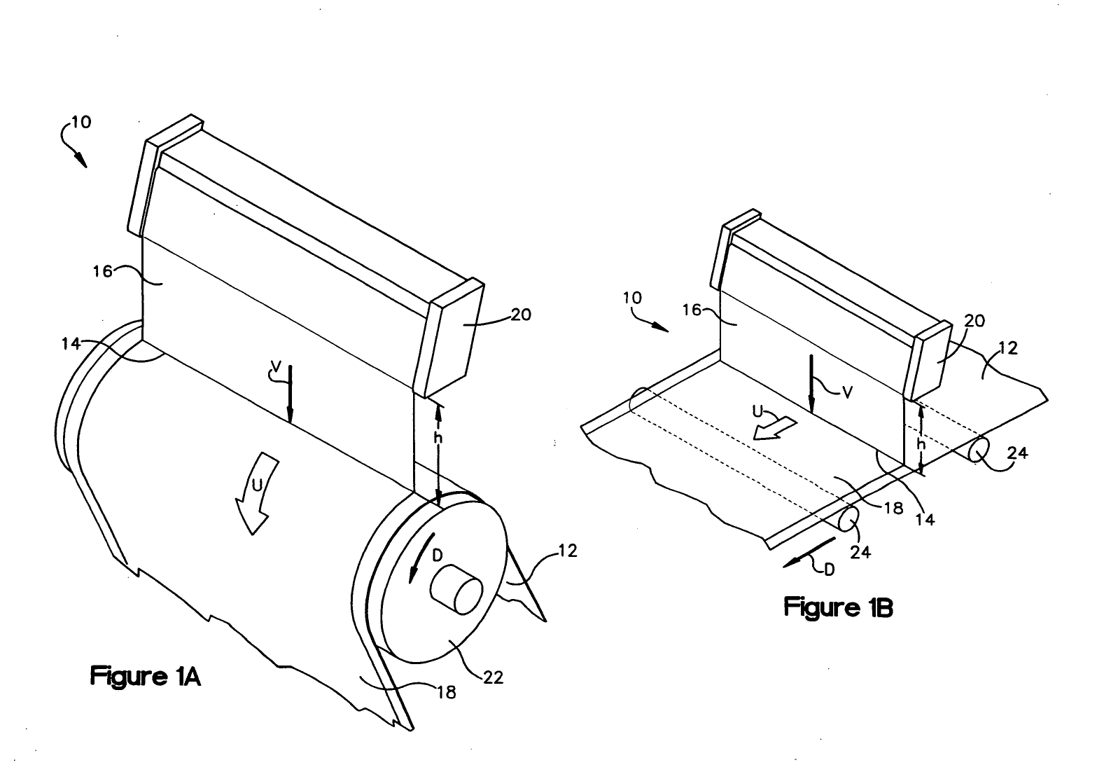

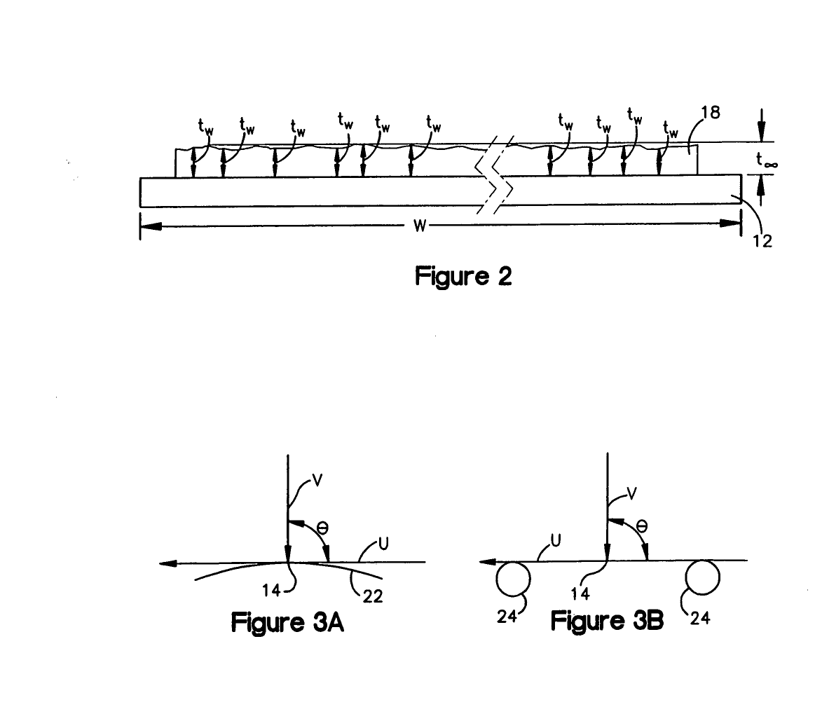

Referring now to the drawings, and initially to FIGS. 1A and 1B, a system 10 for performing a curtain coating method is schematically shown. The method generally comprises the steps of conveying a substrate 12 in a downstream direction (D) through an impingement zone 14, and impinging the substrate 12 with a free-falling curtain 16 in the impingement zone 14 at an impingement angle (θ) to form a coating 18 on the substrate 12 of a desired coating weight (ctwt). As is best seen by referring briefly to FIG. 2, if the curtain coating method is successfully performed, the substrate 12 will be provided with a coating 18 having a thickness (t_{w}) that varies less than 2%, that varies less than 1.5%, that varies less than 1.0%, and/or that varies less than 0.5% from the predetermined uniform coating thickness (t_{∞}) over the width (w) of the coating 18.

The substrate 12 moves through the impingement zone 14 at a substrate velocity (U) and the curtain 16 contacts the substrate 12 at a impingement velocity (V). A conveyor controls the substrate velocity (U) and allows the speed (U) to be set between at least about 300 m/min and about 1000 m/min. In FIG. 1A, the conveyor comprises a back-up roll 22 around which the substrate 12 is moved, and, in FIG. 1B, the conveyor comprises two horizontally spaced rolls 24 between which the substrate 12 is moved. The curtain 16 can be formed by the liquid coating composition falling from a die 20 and the curtain 16 contacts the substrate 12 at an impingement velocity (V). If, for example, the curtain 16 has a height (h) of about 15 cm and its initial velocity (V₀) is about zero, the impingement velocity (V) will be about 1.72 m/s.

As is best seen by referring additionally to FIGS. 3A and 3B, (schematically showing the substrate velocity (U) vector and the impingement velocity (V) vector), the curtain 16 contacts the impingement zone 14 at an impingement angle (θ). In FIG. 3A (corresponding to FIG. 1A), the impingement angle (θ) is the angle between a first line representing gravity (i.e., a vertical line) and a second line tangent to the top-dead-center of the back-up roll 22. In FIG. 3B (corresponding to FIG. 1B), the impingement angle (θ) is the angle between a first line representing gravity (i.e., a vertical line) and a second line parallel to the path created by the conveying rollers 24. In both cases, the second line is horizontal and thus the impingement angle (θ) is equal to 90°.

In the curtain coating method shown in FIGS. 1A and 1B, speed ratios (SP) between about 3 and about 10 can provide successful curtain coating. Specifically, speed ratios (SP) between about 3 and about 4 (e.g., a range contained within the area defined by data points having x-coordinates 2.91, 3.88, 4.85) can accommodate force ratios (Re) from about 1.0 to about 3.5. For an impingement velocity (V) of about 1.72 m/s, this corresponds to a substrate velocity (U) between about 300 m/min and about 500 m/min. For an adhesive coating composition (having a density (ρ) between about 900 kg/m³ and about 1100 kg/m³ and having a viscosity (η) between about 0.040 Pa*s and about 0.160 Pa*s) this corresponds to a volumetric flow rate range (Q) of about 0.00004 m³/(s*m) to about 0.0006 m³/(s*m). (See Tables 2A-2B and 6A-6B, see Graphs 1A-1B.)

Speed ratios (SP) between about 4 and about 5 (e.g., a range contained within the area defined by data points having x-coordinates 3.88, 4.85, 5.81) can accommodate force ratios (Re) from about 1.8 up to about 4.2. For an impingement velocity (V) equal to about 1.72 m/s, this corresponds to a substrate velocity (U) between about 400 m/min and about 600 m/min. For an adhesive coating composition, this corresponds to a volumetric flow rate (Q) range of about 0.000065 m³/(s*m) to about 0.00075 m³/(s*m). (See Tables 2A-2B, 6A-6B, and see Graphs 1A-1B.)

Speed ratios (SP) between about 5 and 6 (e.g., a range contained within the area defined by data points having x-coordinates 4.85, 5.81 and 6.78) can accommodate force ratios (Re) from about 1.9 up to about 5.0. For an impingement velocity (V) equal to about 1.72 m/s, this corresponds to a substrate velocity (U) between about 500 m/min and about 700 m/min. For an adhesive coating composition, this corresponds to a volumetric flow rate (Q) range of about 0.00007 m³/(s*m) to about 0.00089 m³/(s*m). (See Tables 2A-2B, 6A-6B and see Graphs 1A-1B.)

Speed ratios (SP) between about 6 and 7 (e.g., a range contained within the area defined by data points having x-coordinates 5.81, 6.78, 7.75) can accommodate force ratios (Re) from about 2.1 up to about 5.2. For an impingement velocity (V) equal to about 1.72 m/s, this corresponds to a substrate velocity (U) between about 600 m/min and about 800 m/min. For an adhesive coating composition, this corresponds to a volumetric flow rate (Q) range of about 0.000076 m³/(s*m) to about 0.00092 m³/(s*m). (See Tables 2A-2B, 6A-6B, and see Graphs 1A-1B.)

Speed ratios (SP) between 7 and 8 (e.g., a range contained within the area defined by data points having x-coordinates 6.78, 7.75, 8.72) can accommodate force ratios (Re) from about 2.3 to about 5.2. For an impingement velocity (V) equal to about 1.72 m/s, this corresponds to a substrate velocity (U) between about 700 m/min and about 900 m/min. For an adhesive coating composition , this corresponds to a volumetric flow rate (Q) range of about 0.00008 m³/(s*m) to about 0.00092 m³/(s*m). (See Tables 2A-2B, 6A-6B, and see Graphs 1A-1B.)

Speed ratios (SP) between 8 and 9 (e.g., a range contained within the area defined by data points having x-coordinates 7.75, 8.72, 9.69) can accommodate force ratios (Re) from about 2.7 to about 5.2. For an impingement velocity (V) equal to about 1.72 m/s, this corresponds to a substrate velocity (U) between about 800 m/min and about 900 m/min. For an adhesive coating composition, this corresponds to a volumetric flow rate (Q) range of about 0.000098 m³/(s*m) to about 0.00092 m³/(s*m). (See Tables 2A-2B, 6A-6B and see Graphs 1A-1B.)

Speed ratios (SP) between 9 and 10 (e.g., a range contained within the area defined by data points having x-coordinates 8.72 and 9.69) can accommodate force ratios (Re) from about 3.0 to about 5.2. For an impingement velocity (V) equal to about 1.72 m/s, this corresponds to a substrate velocity (U) between about 900 m/min and about 1000 m/min. For an adhesive coating composition, this corresponds to a volumetric flow rate (Q) range of about 0.000109 m³/(s*m) to about 0.00092 m³/(s*m). (See Tables 2A-2B, 6A-6B and see Graphs 1A-1B.)

Thus, speed ratios (SP) between about 3 and about 10 can provide successful curtain coating when the impingement angle (θ) is equal to about 90°. However, speed ratios (SP) between about 3 and about 10 cannot provide successful coating at higher force ratios (Re), that is force ratios (Re) greater than 5.25. (See Tables 2A-2B, 6A-6B, and see Graphs 1A-1B.)

Curtain coating was unsuccessful at high force ratios (Re) because a substantial bank of liquid (i.e., a heel) forms upstream of the impingement zone 14 and, in some cases, air is trapped thereunderneath. Heel formation results in undulated and uneven coating thickness, and excessive air entrapment results in coating-void regions (e.g., empty spots/stripes on the substrate). This leads to an unacceptable level of cross-web defects and the coating 18 having a thickness (t_{w}) that varies 2% or more from the desired final uniform coating thickness (t_{∞}) over the width (w) of the coating 18.

In the past, this problem has been avoided by decreasing the volumetric flow rate (Q) (to thereby reduce the force ratio (Re)) and thus reducing the substrate velocity (U) and compromising the efficiency of the curtain coating process. For example, with an adhesive coating composition, the volumetric flow rate (Q) is limited to 0.00092 m³/(s*m) even if the coating composition has a relatively low density (ρ) (e.g., 900 kg/m³) and a relatively high viscosity (e.g., 0.160 Pa*s).

With a low viscosity coating composition, such as release coating (e.g. a coating composition having a density (ρ) between about 900 kg/m³ and about 1100 kg/m³ and having a viscosity (η) between about 0.005 Pa*s and about 0.015 Pa*s), the volumetric flow rate (Q) is believed to be even more limited. Specifically, for example, speed ratios (SP) between about 3 and about 4 and force ratios (Re) from about 1.0 to about 3.5 would correspond to a volumetric flow rate (Q) range of about 0.000005 m³/(s*m) to about 0.00006 m³/(s*m). Speed ratios (SP) between about 4 and about 5 and force ratios (Re) from about 1.8 up to about 4.2 would correspond to a volumetric flow rate (Q) range of about 0.000008 m³/(s*m) to about 0.00007 m³/(s*m). Speed ratios (SP) between about 5 and 6 and force ratios (Re) from about 1.9 up to about 5.0 would correspond a volumetric flow rate (Q) range of about 0.000009 m³/(s*m) to about 0.00008 m³/(s*m). Speed ratios (SP) between about 6 and 7 and force ratios (Re) from about 2.1 up to about 5.2 would correspond to a volumetric flow rate (Q) range of about 0.000010 m³/(s*m) to about 0.000087 m³/(s*m). Speed ratios (SP) between 7 and 8 and force ratios (Re) from about 2.3 to about 5.2 would correspond to a volumetric flow rate (Q) range of about 0.000010 m³/(s*m) to about 0.000087 m³/(s*m). Speed ratios (SP) between 8 and 9 and force ratios (Re) from about 2.7 to about 5.2 would correspond to a volumetric flow rate (Q) range of about 0.000012 m³/(s*m) to about 0.000087 m³/(s*m). Speed ratios (SP) between 9 and 10 and force ratios (Re) from about 3.0 to about 5.2 would correspond to a volumetric flow rate (Q) range of about 0.000014 m³/(s*m) to about 0.000087 m³/(s*m). Thus, with a release coating composition, the volumetric flow rate (Q) can be limited to 0.000087 m³/(s*m) even if the coating composition has a relatively low density (ρ) (e.g., 900 kg/m³) and a relatively high viscosity (e.g., 0.015 Pa*s).

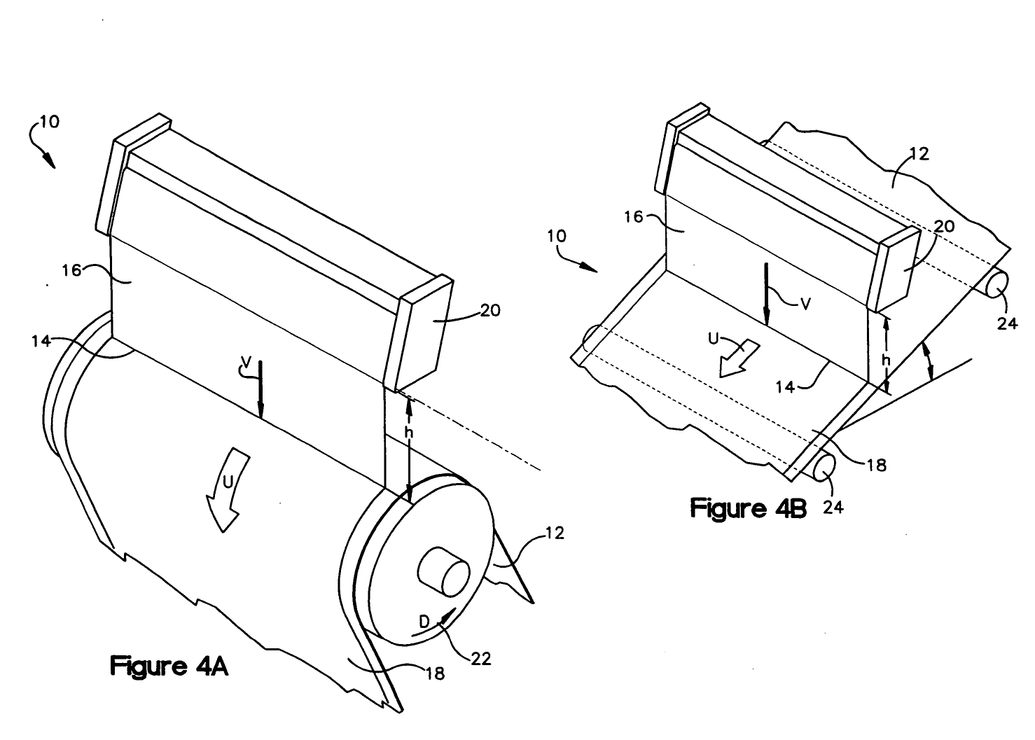

Referring now to FIGS. 4A and 4B, a curtain coating method according to the present invention is schematically shown. This curtain coating system 10 is the same as that discussed above (whereby like references are used) except that the impingement angle (θ) is not equal to 90°. Instead, the impingement angle (θ) is less than 90°, not greater than about 65°, not greater than about 60°, not greater than about 55°, is between about 70° and about 50° and/or is between about 65°0 and about 55°. In FIG. 4A, the impingement zone 14 is offset in the downstream direction (D) from the top-dead-center of the back-up roller 22. In FIG. 4B, the conveying rollers 24 are vertically offset to slope in the downstream direction (D).

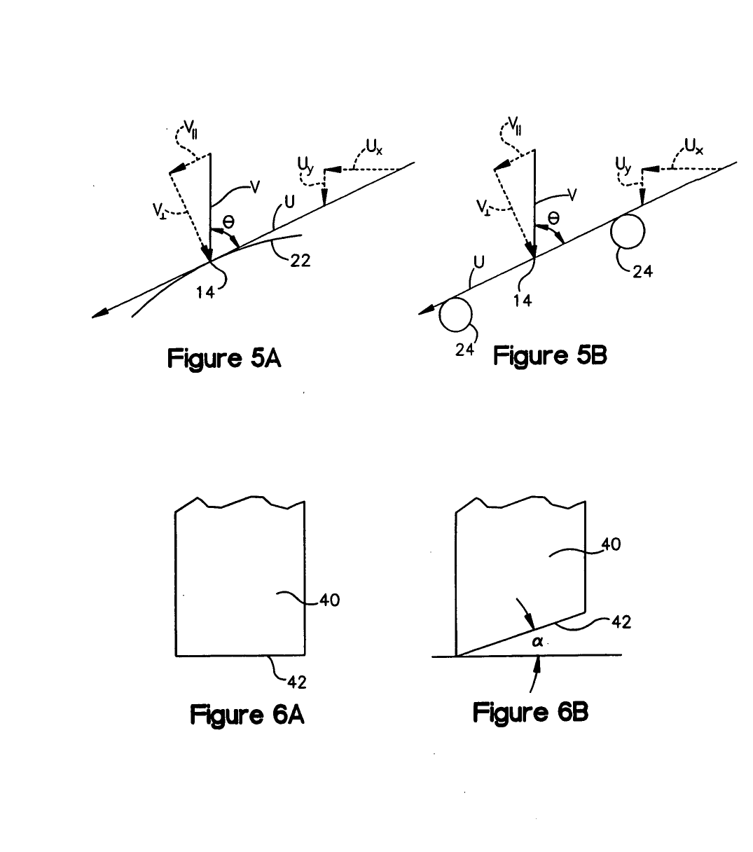

As is best seen by referring additionally to FIGS. 5A and 5B, the impingement velocity (V) vector can be viewed as having a component (V_{⊥}) perpendicular to the substrate velocity (U) vector and a component (V_{∥}) parallel to the substrate velocity (U) vector. The perpendicular component (V_{⊥}) corresponds to the sine of the impingement angle (V_{⊥}=V sin θ) and the parallel component (V_{∥}) corresponds to the cosine of the impingement angle (V_{∥}=V cos θ). Also, the substrate velocity (U) vector can be viewed as having a horizontal component (Uₓ), corresponding to the sine of the impingement angle (Uₓ=U sin θ), and a vertical component (U_{y}), corresponding to the cosine of the impingement angle (U_{y}=U cos θ).

The present invention includes the appreciation that the most telling speed ratio (SP) is not simply be the ratio (U/V) of the substrate velocity (U) to the impingement velocity (V), but rather a ratio properly representing the velocity shift at the impingement zone 14. Specifically, the parallel component (V_{∥}) of the impingement velocity (V) does not necessitate any velocity shift at the impingement zone 14. Likewise, only the perpendicular component (V_{⊥}) of the impingement velocity (V) vector requires a velocity shift in the impingement zone 14. Accordingly, the important dimensionless speed ratio (SP) is the ratio of the substrate velocity (U) to the perpendicular component (V_{⊥}) of the impingement velocity (V). It may be noted that when the impingement angle (θ) was equal to 90° (FIGS. 1A/3A and 1B/3B, and Tables 2A-2B), the perpendicular component (V_{⊥}) was equal to the impingement velocity (V) and the speed ratio (SP) reduced to the ratio of the substrate speed (U) to the impingement speed (V).

The present invention also includes the appreciation that the vertical component (U_{y}) of the substrate velocity (U) is significant in that it provides a gravitational “push” or downward momentum to the impinging liquid coating composition. While not wishing to be bound by theory, this “push” is believed to move otherwise heel-forming and/or air-entrapping impinging liquid through the impingement zone. It may be noted that when the impingement angle (θ) was equal to 90°, the vertical component (U_{y}) of the substrate velocity (U) was equal to zero and such a “push” was not provided to the impinging liquid.

Successful curtain coating can be accomplished at higher force ratios (Re) when the impingement angle (θ) is less than 90°, and in the tabulated/graphed embodiment of the invention, is equal to about 65°, about 60°, and/or about 55°. Specifically, for example, curtain coating was successful even when the curtain Reynold's number (Re) exceeded about 5.25, exceeded about 5.50, exceeded 6.00, exceeded 6.50, exceeded 7.00, exceeded 7.50, and/or exceeded 8.00. (See Tables 3A, 4A, 5A, 6A and see Graphs 2A, 3A, 4A.)

Specifically, force ratios (Re) from about 5.2 to about 6.0 (e.g., a range contained within the area defined by the data points having y-coordinates 5.220, 5.510, 5.766, 5.966, 6.198) are compatible with speed ratios (SP) between about 7.5 and about 9.5. For an impingement velocity (V) of about 1.72 m/s, this corresponds to a substrate velocity (U) range of about 700 m/min to about 800 m/min. For an adhesive coating composition (e.g. a coating composition having a density (ρ) between about 900 kg/M³ and about 1100 kg/M³ and having a viscosity (η) between about 0.040 Pa*s and about 0.160 Pa*s) this corresponds to a volumetric flow rate (Q) range of about 0.000189 m³/(s*m) to about 0.00107 m³/(s*m). (See Tables 3A-3B, 4A-4B, 5A-5B, 6A-6B and see Graphs 2A-2B, 3A-3B, 4A-4B.)

Force ratios (Re) between about 6 and 7 (e.g., a range contained within the area defined by the data points having y-coordinates 5.966, 6.198, 6.590, 6.712, 6.887, 7.414) are compatible with speed ratios (SP) between about 8.6 and about 11.9. For an impingement velocity of about 1.72 m/s, this corresponds to an about 800 m/min to about 1000 m/min substrate velocity (U) range. For an adhesive coating composition, this corresponds to a volumetric flow rate (Q) range of about 0.000218 m³/(s*m) to about 0.00124 m³/(s*m). (See Tables 3B-3B,4A-4B,5A-5B, 6A-6B and see Graphs 2A-2B, 3B-3B.)

Force ratios (Re) between about 7 and 8 (e.g., a range contained within the area defined by the data points having y-coordinates 6.887,7.414,7.458, 8.238) are compatible with speed ratios (SP) between about 9.6 and 11.9. For an impingement velocity (V) of about 1.72 m/s, this corresponds to an about 900 m/min to about 1000 m/min substrate velocity (U) range. For an adhesive coating composition, this corresponds to a volumetric flow rate (Q) range of about 0.000255 m³/(s*m) to about 0.00142 m³/(s*m). (See Tables 3B-3B, 4A-4B, 5A-5B, 6A-6B and see Graphs 2A-2B, 3B-3B, 4A-4B.)

Force ratios (Re) above 8 (e.g., a range contained within the area defined by the data points having y-coordinates 8.238) are compatible with speed ratios (SP) between about 10.7 and about 11.9 For an impingement velocity (V) of about 1.72 m/s, this corresponds to an about 1000 m/min substrate velocity (U). For an adhesive coating composition, this corresponds to a volumetric flow rate (Q) as high as 0.0147 m³/(s*m) if the coating composition has a relatively low density (ρ) (e.g., 900 kg/m³) and a relatively high viscosity (e.g., 0.160 Pa*s). (See Tables 3B-3B, 4A-4B, 5A-5B, 6A-6B and see Graphs 2A-2B, 3B-3B, 4A-4B.)

With a low viscosity coating composition, such as a release coating (e.g. a coating composition having a density (ρ) between about 900 kg/m³ and about 1100 kg/m³ and having a viscosity (η) between about 0.005 Pa*s and about 0.015 Pa*s), similar flow rate (Q) increases are believed to be obtainable with the present invention. Specifically, force ratios (Re) from about 5.2 to about 6.0 and speed ratios (SP) between about 7.5 and about 9.5 correspond to a volumetric flow rate (Q) range of about 0.000024 m³/(s*m) to about 0.000100 m³/(s*m). Force ratios (Re) between about 6 and 7 and speed ratios (SP) between about 8.6 and about 11.9 correspond to a volumetric flow (Q) range of about 0.000027 m³/(s*m) to about 0.000117 m³/(s*m). Force ratios (Re) between about 7 and 8 and speed ratios (SP) between about 9.6 and 11.9 correspond to a volumetric flow (Q) range of about 0.000032 m³/(s*m) to about 0.000133 m³/(s*m). Force ratios (Re) above 8 and speed ratios (SP) between about 10.7 and about 11.9 correspond to volumetric flows from about 0.000036 m³/(s*m) to above 0.000136 m³/(s*m).

Speed ratios (SP) between about 7.5 and about 8.0 (e.g., a range contained within the area defined by the data points having x-coordinates 7.48, 7.83, 8.28) can accommodate force ratios (Re) up to about 5.9 (e.g., less than about 6.0). Speed ratios (SP) between about 8.0 and 9.0 (e.g., a range contained within the area defined by the data points having x-coordinates 7.83, 8.28, 8.55, 8.95, 9.46) can accommodate force ratios (Re) up to about 6.8 (e.g., less than about 7.0). Speed ratios (SP) between about 9.0 and 10.5 (e.g., a range contained within the area defined by the data points having x-coordinates 8.95, 9.46, 9.62, 10.07, 10.65) can accommodate force ratios (Re) up to about 7.4 (e.g., less than about 7.5). Speed ratios (SP) between about 10.5 and 12.0 (e.g., a range contained within the area defined by the data points having x-coordinates 10.07, 10.65, 10.69, 11.19, 11.83) can accommodate force ratios (Re) up to about 8.2 (e.g., less than 8.5). (See Tables 3B, 4B, 5B, 6B and see Graphs 2B, 3B, 4B.)

Substrate velocities (U) having horizontal components (Uₓ) between about 600 m/min and about 900 m/min can accommodate force ratios (Re) greater than 5.25. Specifically, horizontal components (Uₓ) between about 600 m/min and about 700 m/min (e.g., a range contained within the area defined by the data points having x-coordinates 573, 606, 634, 655, 693, 725) can accommodate force ratios (Re) up to about 6.6 (e.g., less than 7.0). Horizontal components (Uₓ) between about 700 m/min and about 800 m/min (e.g., a range contained within the area defined by the data points having x-coordinates 693, 725, 737, 779, 816) can accommodate force ratios (Re) up to about 7.4 (e.g., less than 7.5). Horizontal components (Uₓ) between about 800 m/min and about 900 m/min (e.g., a range contained within the area defined by the data points having x-coordinates 779, 816, 866, 906) can accommodate force ratios (Re) up to about 8.2 (e.g., less than 8.5).

Substrate velocities (U) having vertical components (U_{y}) between about 300 m/min and about 600 m/min can accommodate force ratios (Re) greater than 5.25. Specifically, vertical components (U_{y}) between about 300 m/min and about 350 m/min (e.g., a range contained within the area defined by the data points having x-coordinates 296, 338, 350, 380) can accommodate force ratios (Re) up about 6.6 (e.g., less than about 7.0). Vertical components (U_{y}) between about 350 m/min and about 400 m/min (e.g., a range contained within the area defined by the data points having x-coordinates 338, 350, 380, 400, 402) can accommodate force ratios (Re) up about 7.4 (e.g., less than about 7.5). Vertical components (U_{y}) between about 400 m/min and about 600 m/min (e.g., a range contained within the area defined by the data points having x-coordinates 380, 400, 402, 423, 450, 459, 500, 516, 574) can accommodate force ratios (Re) up to at least about 8.2 (e.g., less than about 8.5).

Impingement velocities (V) having perpendicular components (V_{⊥}) between about 1.4 m/s and about 1.6 m/s (e.g. a range contained within the area defined by the data points having x-coordinates 1.41, 1.49, 1.56) can accommodate force ratios (Re) greater than 5.25 and up to at least 8.2. Impingement velocities (V) having parallel components (V_{∥}) between about 0.7 m/s and about 1.0 m/s (e.g. a range contained within the area defined by the data points having x-coordinates 0.73, 0.86, 0.99) can accommodate high ratios (Re) greater than 5.25 and up to at least 8.2. Successful curtain coating was obtained at these impingement velocity components (V_{⊥}, V_{∥}) when the substrate velocity (U) was between about 700 m/min and 1000 m/min, when the horizontal component (Uₓ) of the substrate velocity (U) was between about 570 m/min and 910 m/min, and when the vertical component (U_{y}) of the substrate velocity (U) was between about 300 m/min and about 600 m/min.

Significantly, curtain coating was also successful at lower force ratios (Re) for these acute impingement angles. Specifically, force ratios (Re) between about 1 and 2 (e.g., a range contained within the area defined by the data points having y-coordinates 1.01, 1.34, 1.68, and 2.02) are compatible with speed ratios (SP) between about 3.2 and about 6.4. For an impingement velocity (V) of about 1.72 m/s, this corresponds to an about 300 m/min to 600 m/min substrate velocity (U) range. For an adhesive coating composition (e.g. a coating composition having a density (ρ) between about 900 kg/m³ and about 1100 kg/m³ and having a viscosity (η) between about 0.040 Pa*s and about 0.160 Pa*s) this corresponds to a volumetric flow rate (Q) range of about 0.000036 m³/(s*m) to about 0.000356 m³/(s*m). For a release coating composition (e.g. a coating composition having a density (ρ) between about 900 kg/M³ and about 1100 kg/M³ and having a viscosity (η) between about 0.005 Pa*s and about 0.015 Pa*s) this corresponds to a volumetric flow rate (Q) range of about 0.000005 m³/(s*m) to about 0.000033 m³/(s*m). (See Tables 3B, 4A, 5A, 6A and see Graphs 2A, 3B, 4A.)

Force ratios (Re) between about 2 and 3 (e.g., a range contained within the area defined by the data points having y-coordinates 1.68, 2.02, 2.06, 2.24, 2.35, 2.47, 2.69, 2.76, 2.98, 3.02) are compatible with speed ratios (SP) between about 3.2 and about 9.6. For an impingement velocity (V) of about 1.72 m/s, this corresponds to an about 300 m/min to about 900 m/min substrate velocity (U) range. For an adhesive coating composition, this corresponds to a volumetric flow rate (Q) range of about 0.000073 m³/(s*m) to about 0.000533 m³/(s*m). For a release coating composition, this corresponds to a volumetric flow rate (Q) range of about 0.000009 m³/(s*m) to about 0.000050 m³/(s*m). (See Tables 3B, 4A, 5A, 6A and see Graphs 2A, 3B, 4A.)

Force ratios (Re) between about 3 and 4 (e.g., a range contained within the area defined by the data points having y-coordinates 2.98, 3.02, 3.29, 3.36, 3.44, 3.73, 4.12) are compatible with speed ratios (SP) between about 4.3 and about 10.7. For an impingement velocity of about 1.72 m/s, this corresponds to an about 400 m/min to about 1000 m/min substrate velocity (U) range. For an adhesive coating composition, this corresponds to a volumetric flow rate (Q) range of about 0.000109 m³/(s*m) to about 0.000711 m³/(s*m). For a release coating composition, this corresponds to a volumetric flow rate (Q) range of about 0.000014 m³/(s*m) to about 0.000067 m³/(s*m). (See Tables 3B, 4A, 5A, 6A and see Graphs 2A, 3B, 4A.)

Force ratios (Re) between about 4 and about 5.20 (e.g., a range contained within the area defined by the data points having y-coordinates 3.73, 4.12, 4.13, 4.47, 4.82, 4.95, 5.22, 5.51) are compatible with speed ratios (SP) between about 5.3 and about 7.5. For an impingement velocity (V) of about 1.72 m/s, this corresponds to an about 500 m/min to about 700 m/min substrate velocity (U) range. For an adhesive coating composition, this corresponds to a volumetric flow rate (Q) range of about 0.000145 m³/(s*m) to about 0.000924 m³/(s*m). For a release coating composition, this corresponds to a volumetric flow rate (Q) range of about 0.000018 m³/(s*m) to about 0.000087 m³/(s*m). (See Tables 3B, 4A, 5A, 6A and see Graphs 2A, 3B, 4A.)

Additionally, speed ratios (SP) between about 3 and about 4 (e.g., a range contained within the area defined by the data points having y-coordinates 3.21, 4.28) can accommodate force ratios (Re) between about 1.0 and 1.3. Speed ratios (SP) between about 4 and 5 (e.g., a range contained within the area defined by the data points having y-coordinates 3.21, 4.28, 5.35) can accommodate force ratios (Re) between about 1.3 and about 4.1. Speed ratios (SP) between about 5 and about 6 (e.g., a range contained within the area defined by the data points having y-coordinates 4.28, 5.35, 5.81, 6.42) can accommodate low force ratios (Re) between about 1.7 and about 4.5. Speed ratios (SP) between about 6 and about 7 (e.g., a range contained within the area defined by the data points having y-coordinates 5.35, 6.42, 7.48) can accommodate force ratios (Re) between about 2.0 and about 5.0. Speed ratios (SP) between about 7 and about 8 (e.g., a range contained within the area defined by the data points having y-coordinates 6.42, 7.48, 8.55) can accommodate force ratios (Re) between about 2.3 and 5.2. Speed ratios (SP) between about 8 and about 9 (e.g., a range contained within the area defined by the data points having y-coordinates 7.48, 8.55, 9.62) can accommodate force ratios (Re) between about 2.7 and about 5.2. Speed ratios (SP) between about 9 and about 10 (e.g., a range contained within the area defined by the data points having y-coordinates 8.55, 9.62, 10.69) can accommodate force ratios (Re) between about 3.0 and about 5.2. (See Tables 3B, 4B, 5B, 6B, and see Graphs 2B, 3B, 4B.)

Because curtain coating was also successful at lower force ratios (Re) for these acute impingement angles, the same curtain-coating equipment, and/or the same equipment set-up, may be used over a wide range of curtain flow characteristics. In other words, the system 10 need not be modified to accommodate runs wherein a curtain 16 will have a relatively low (i.e., less than 5.25) force ratio (Re).

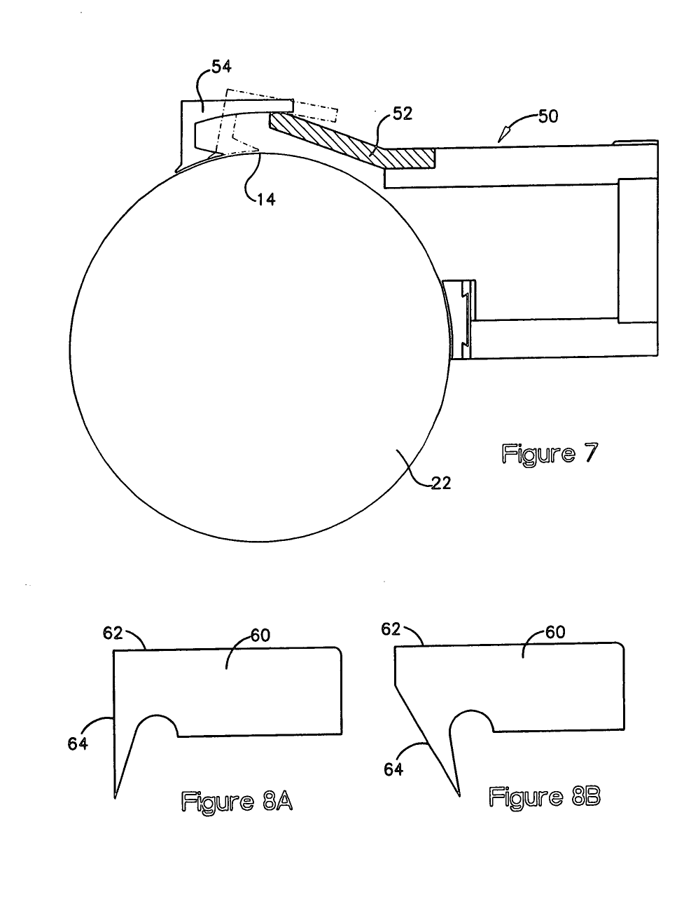

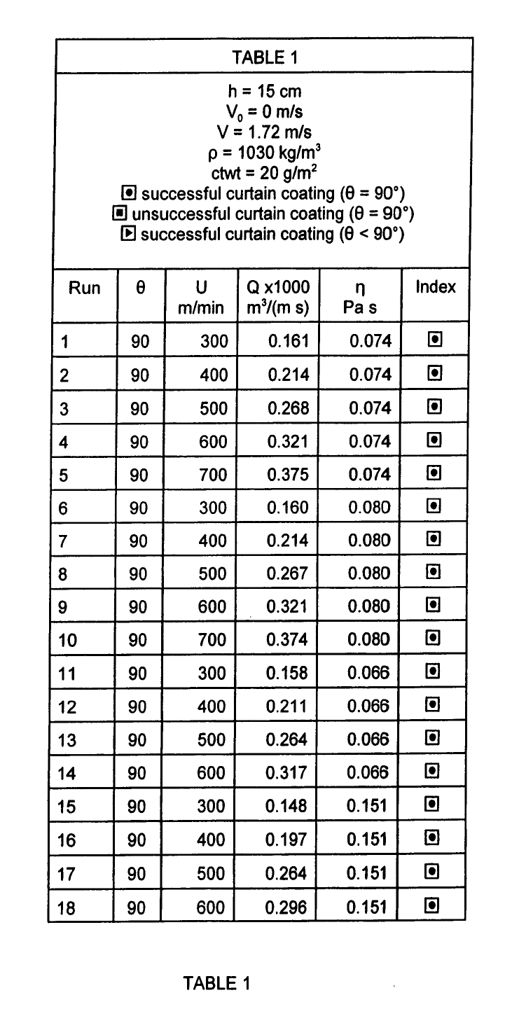

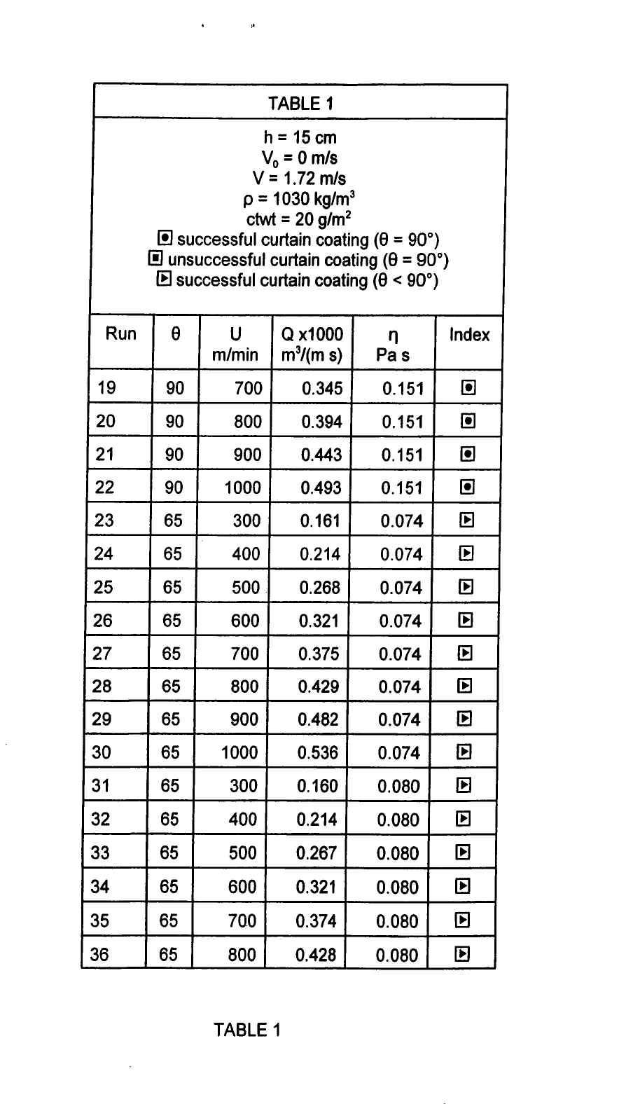

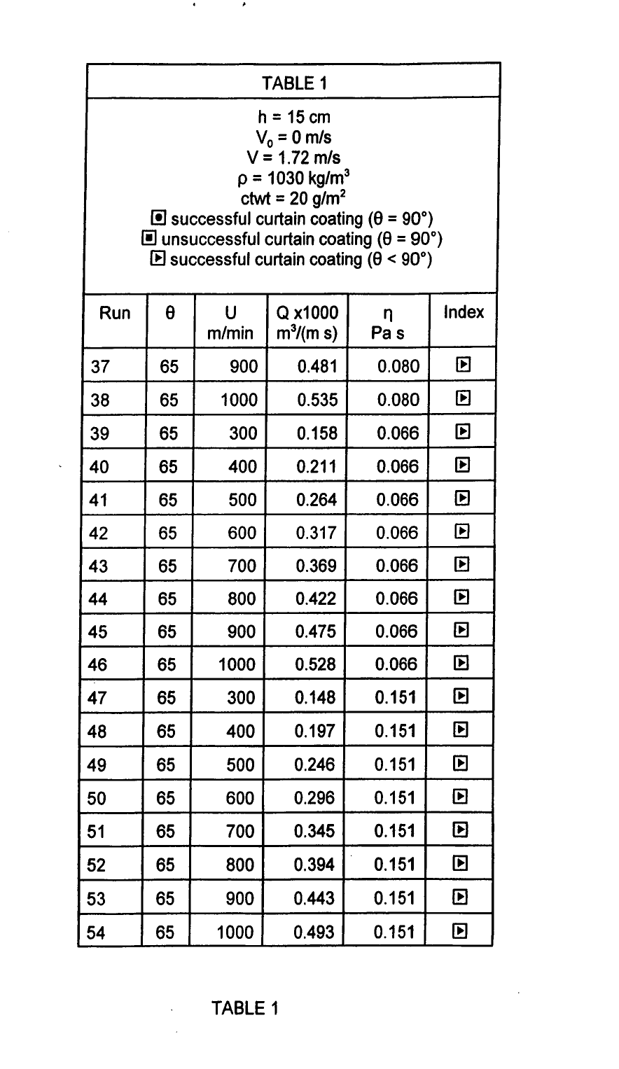

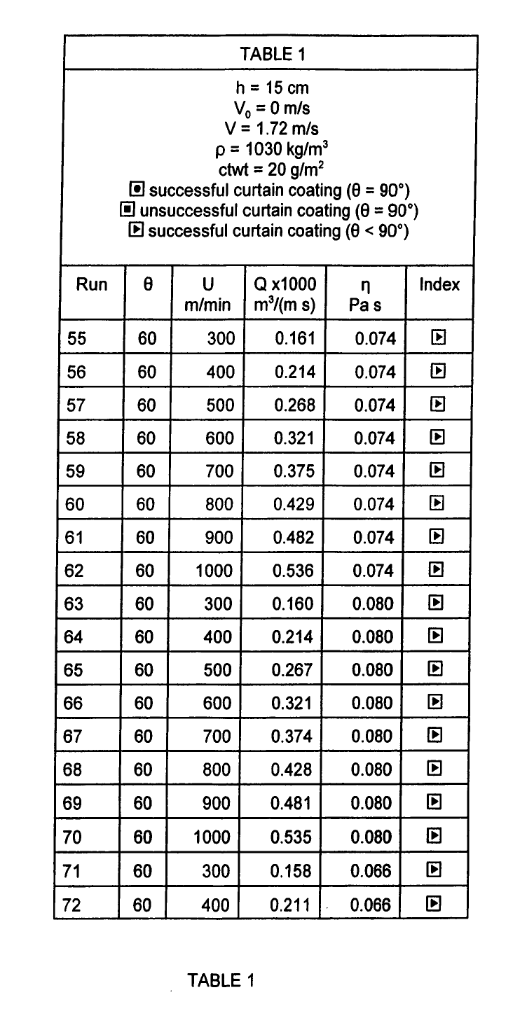

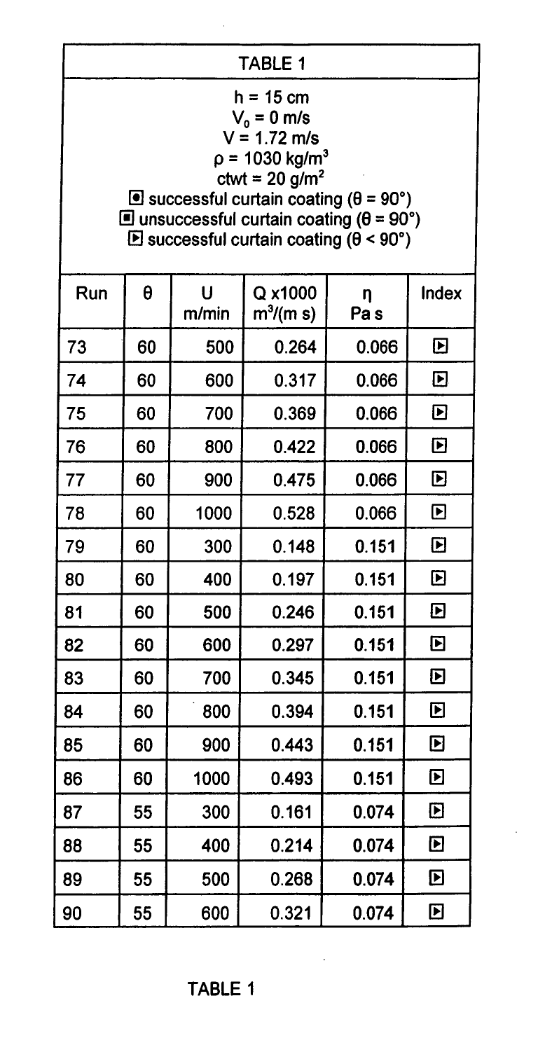

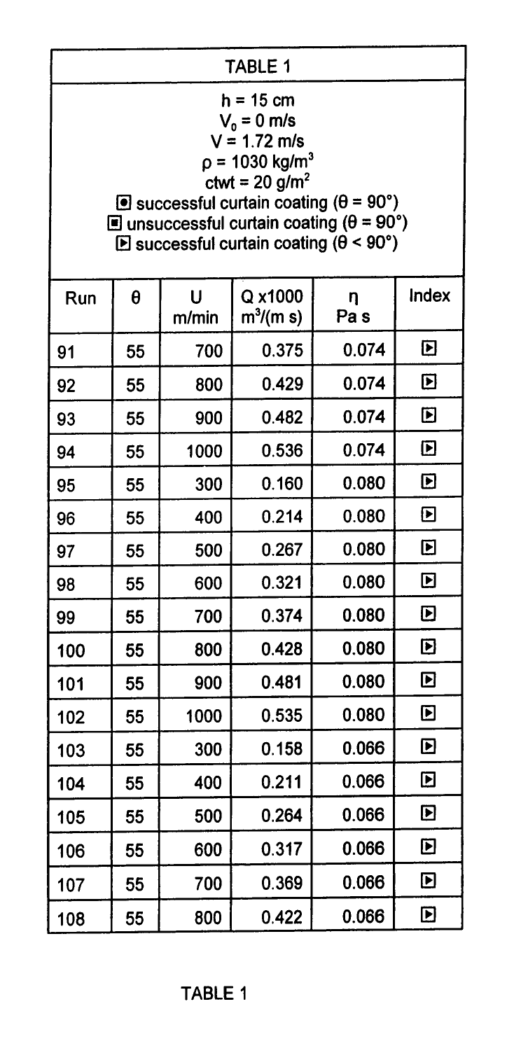

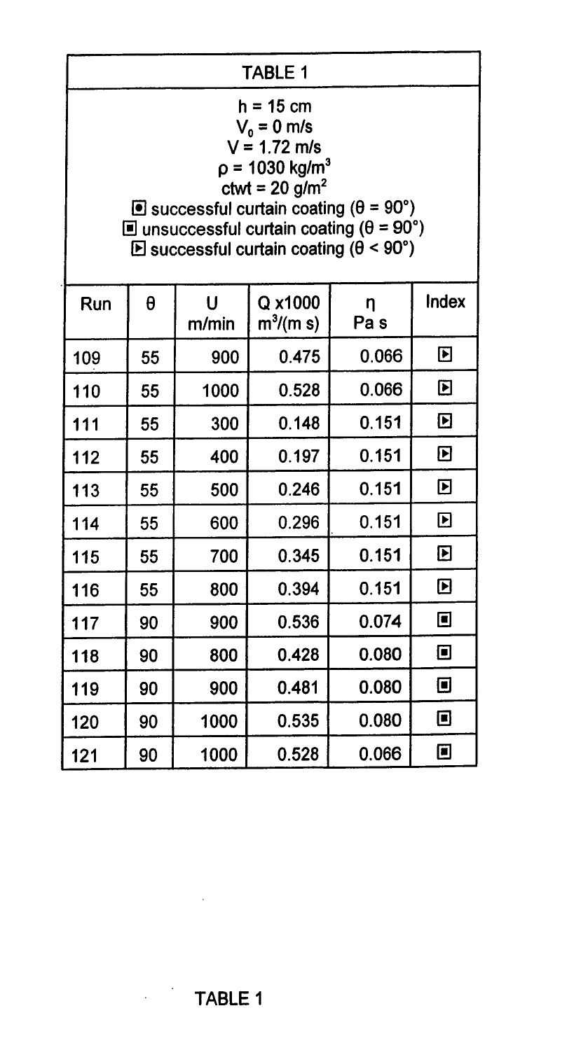

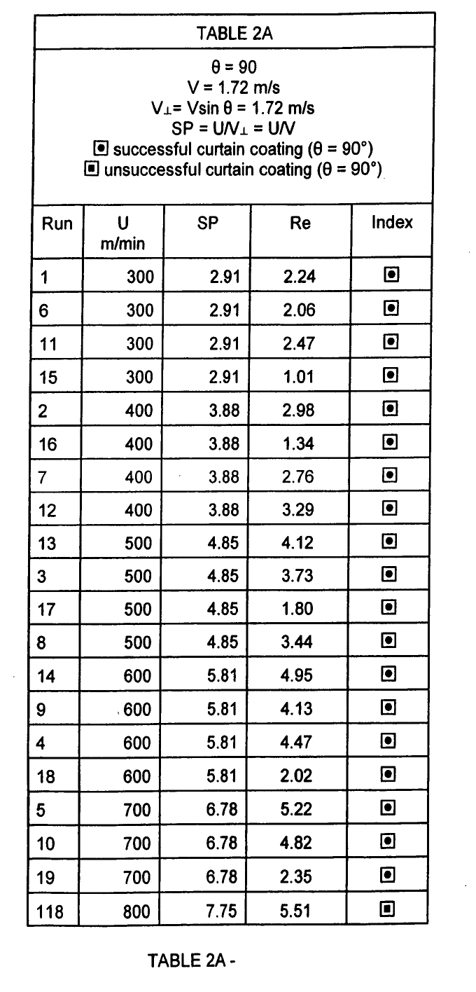

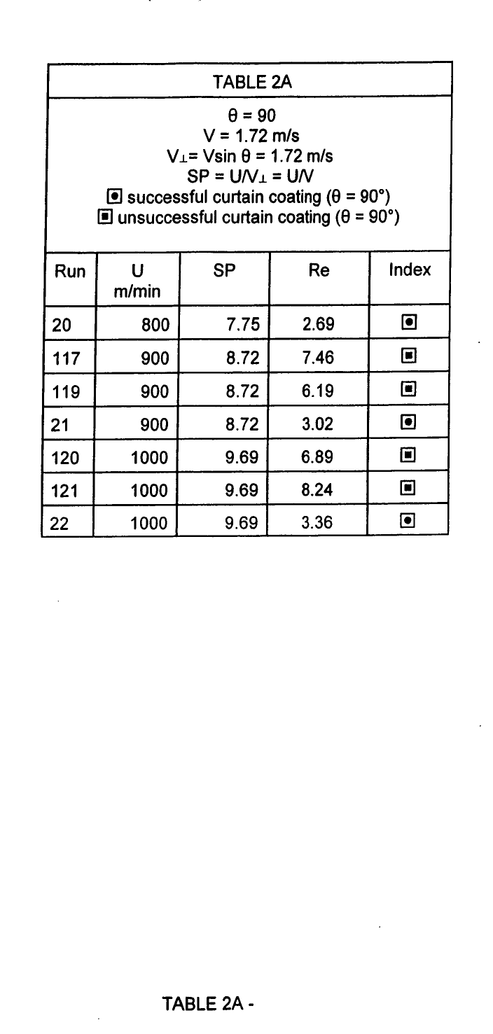

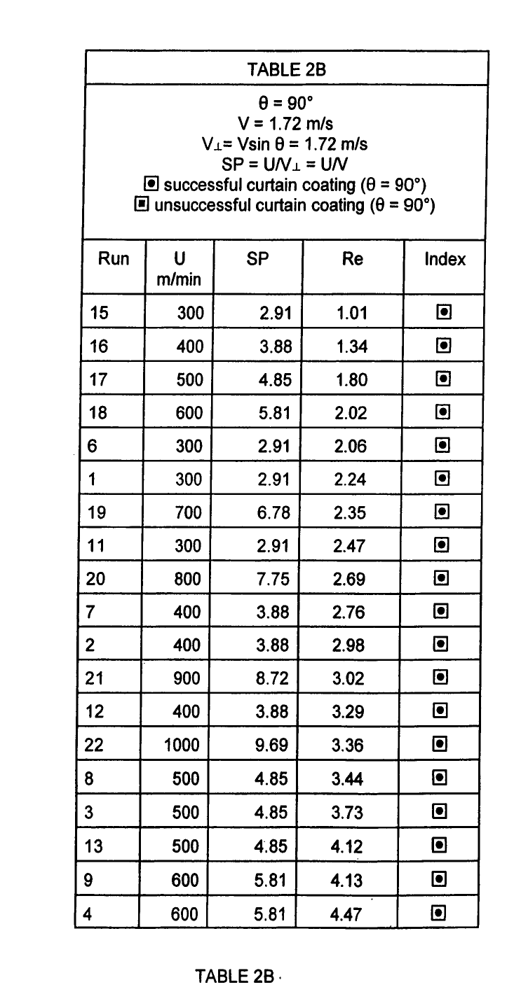

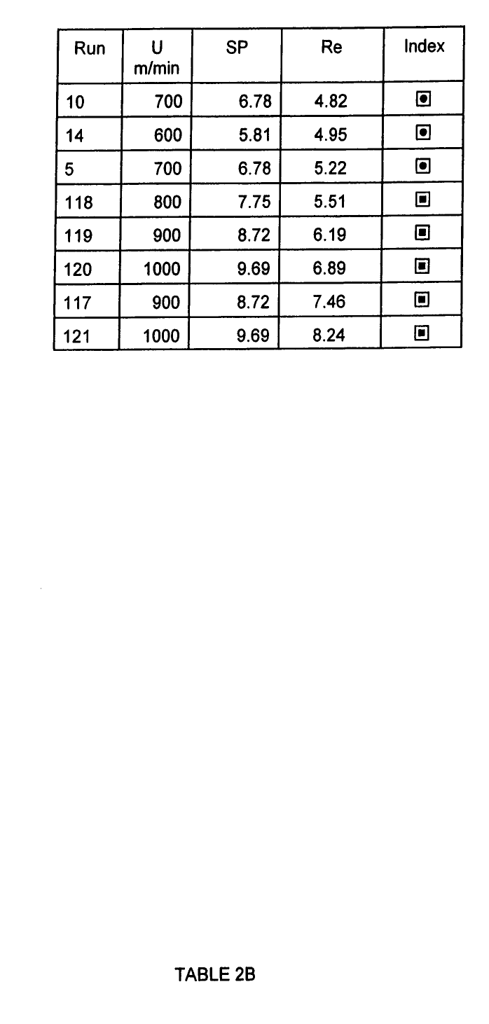

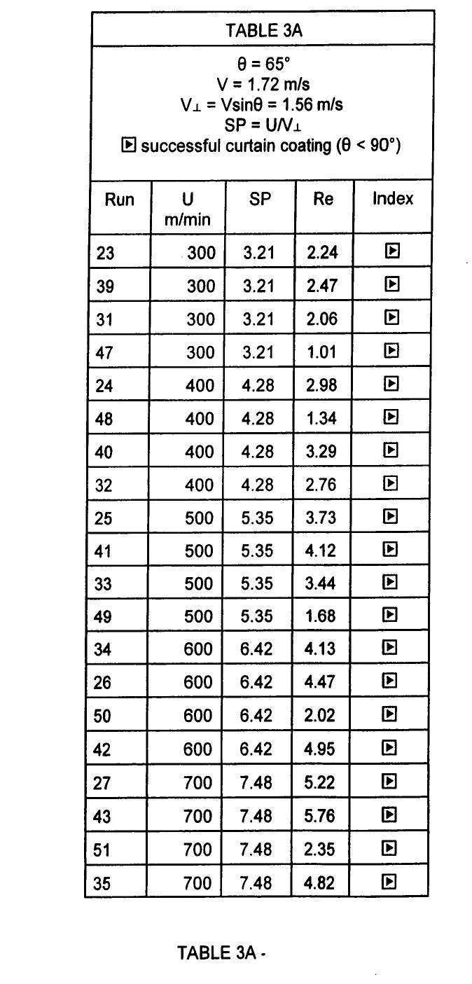

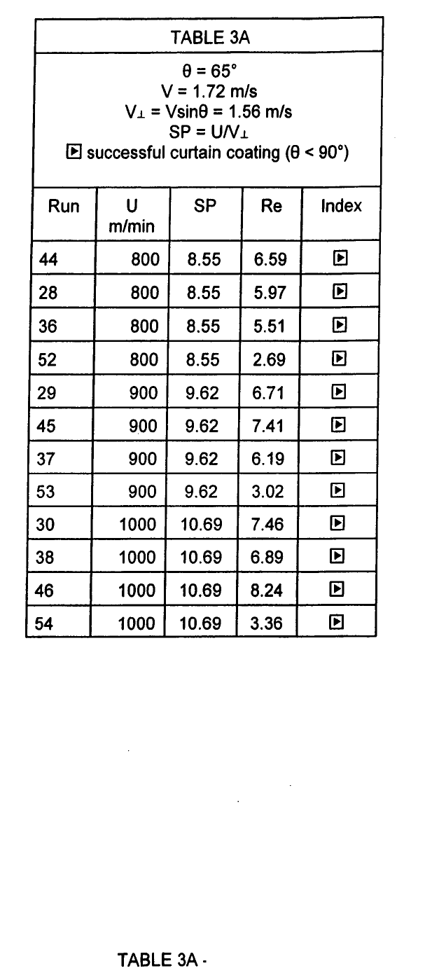

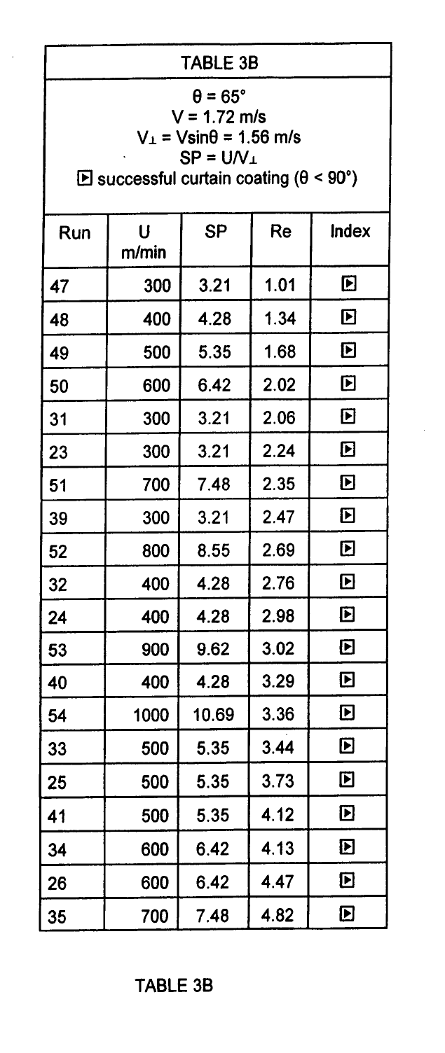

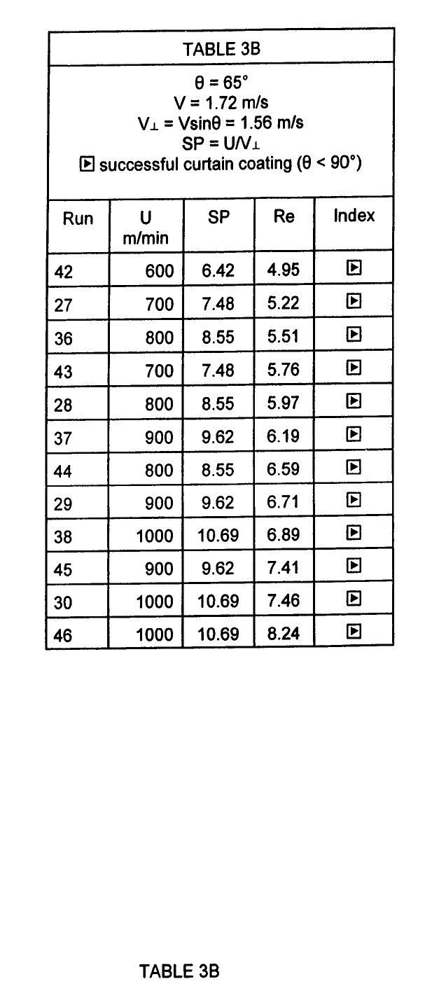

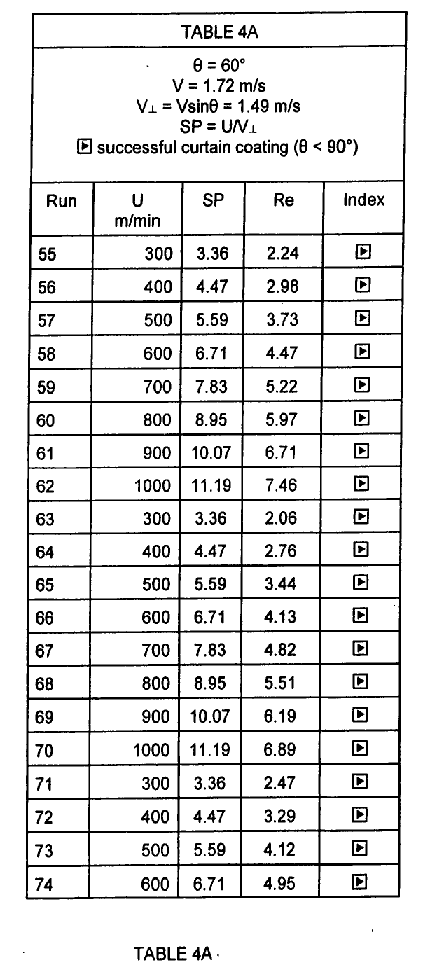

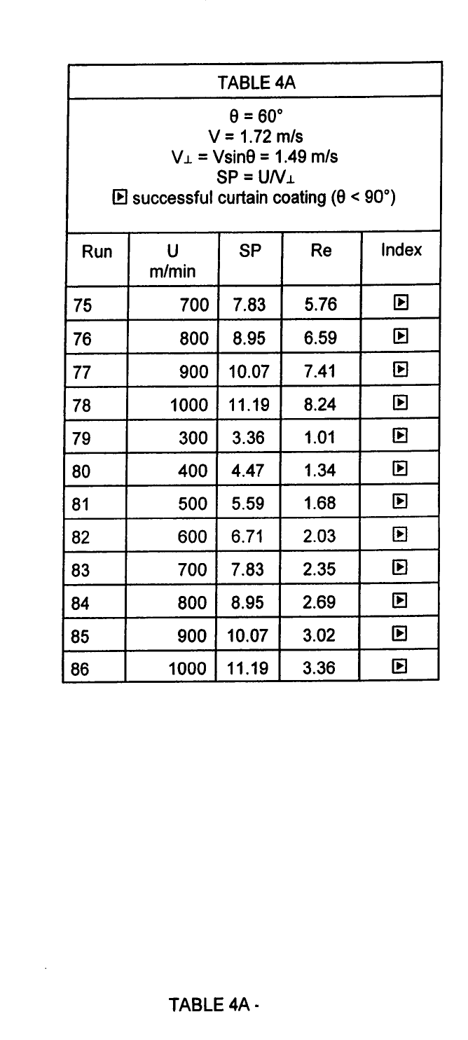

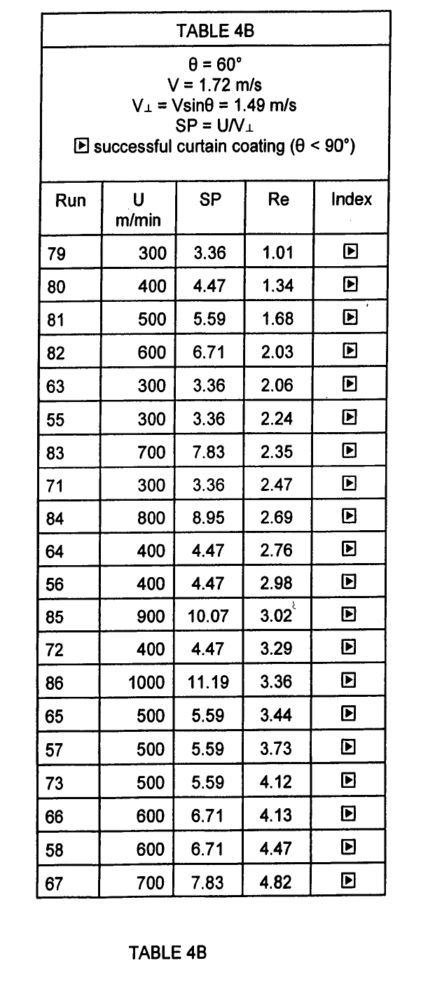

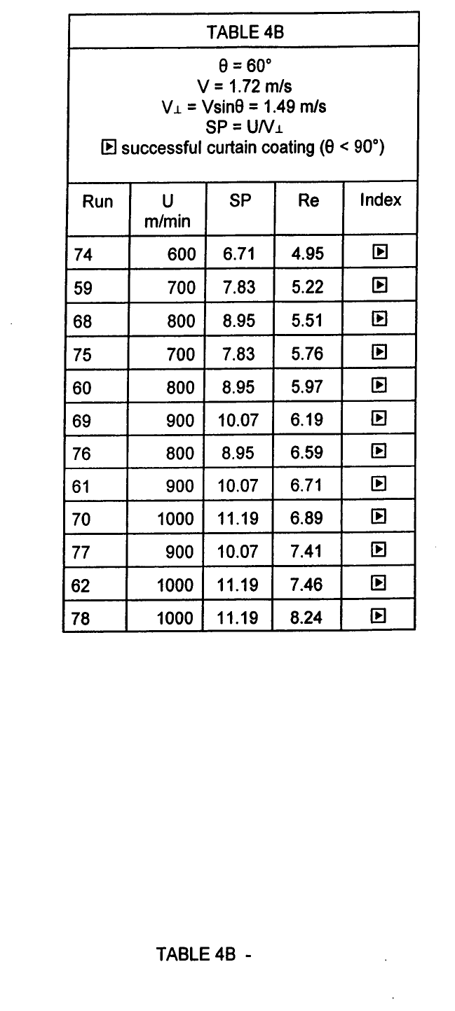

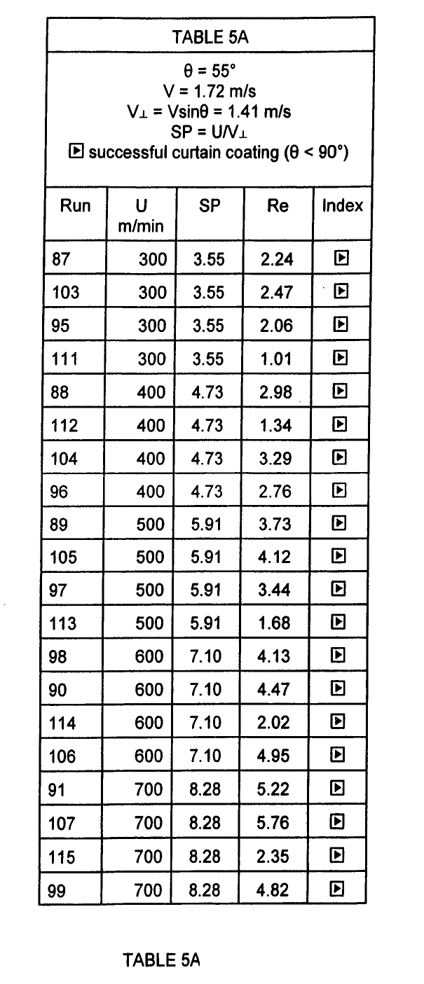

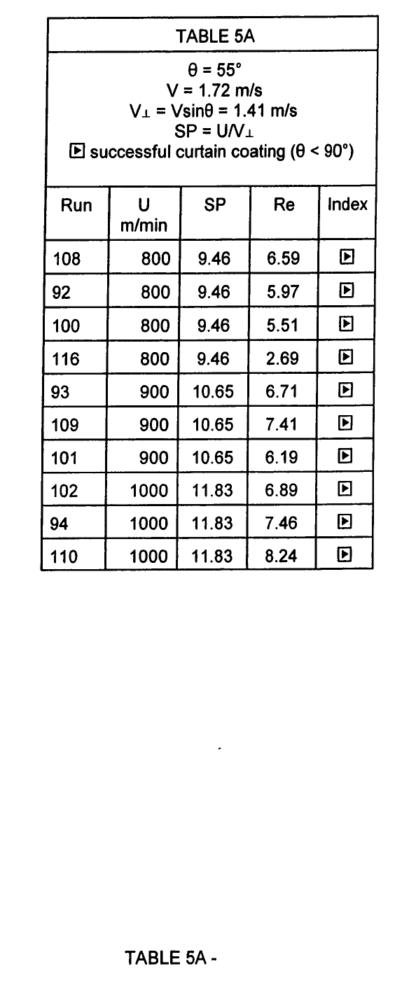

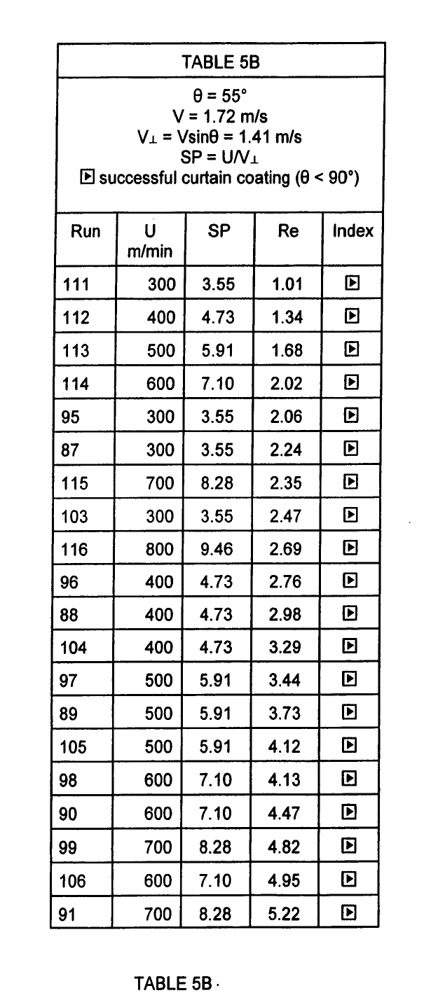

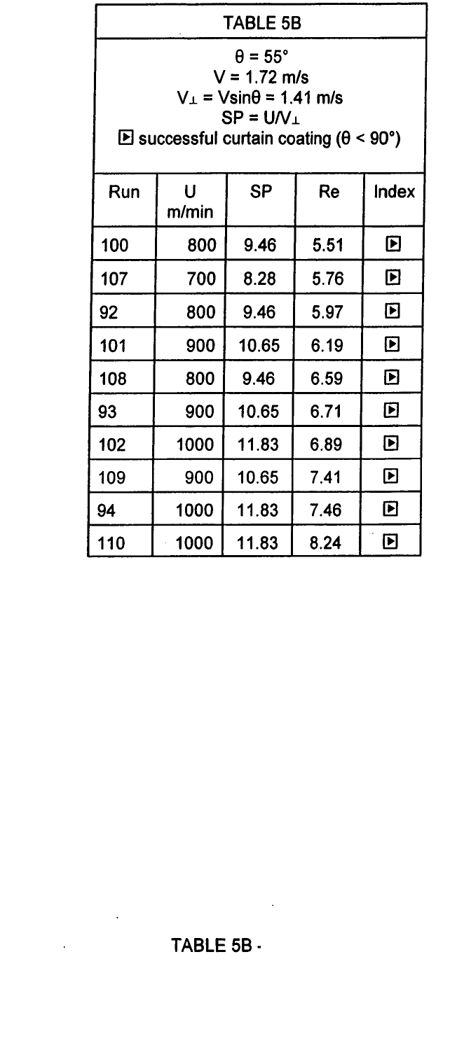

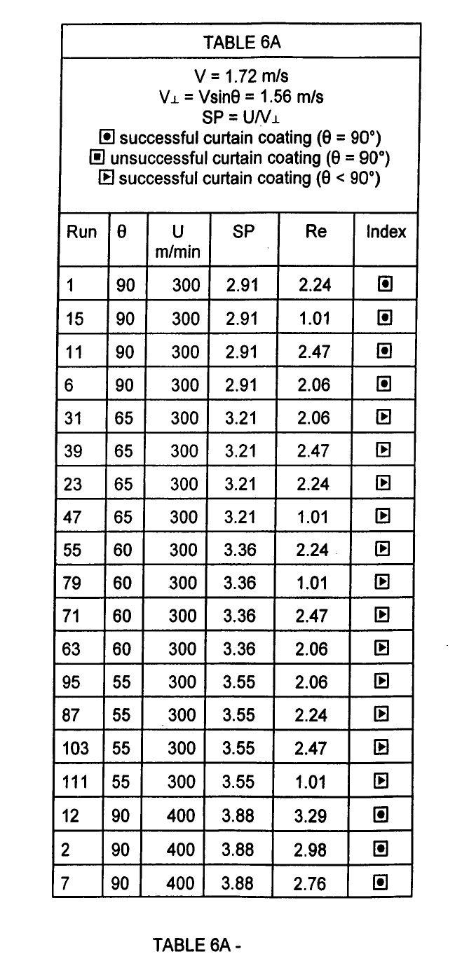

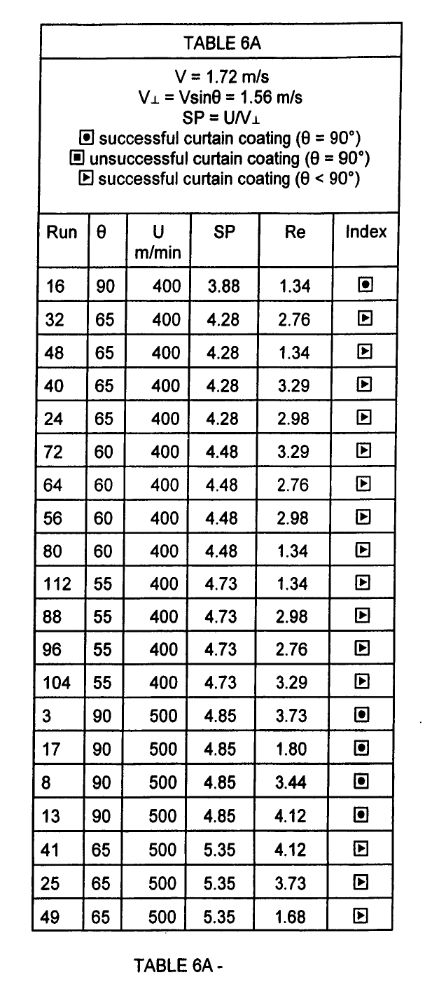

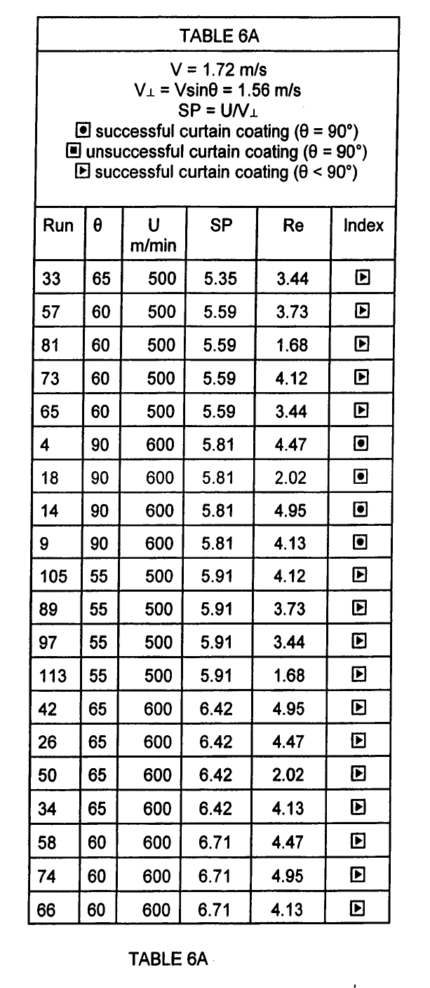

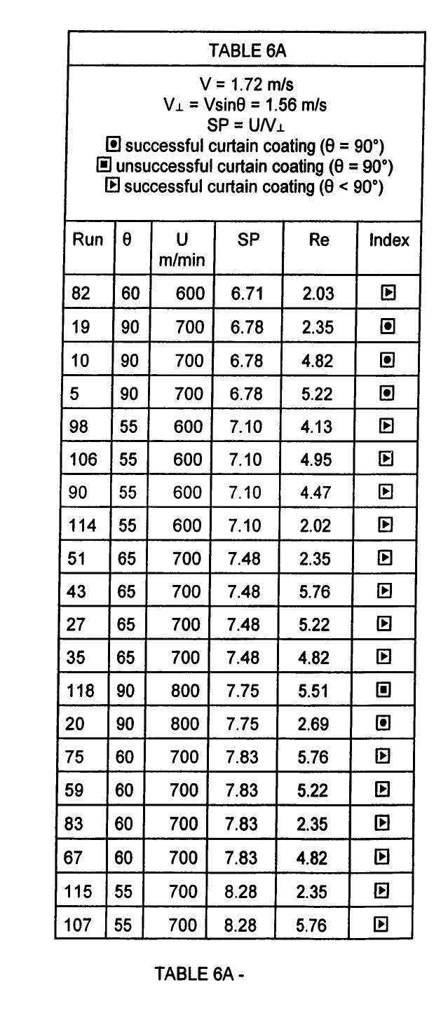

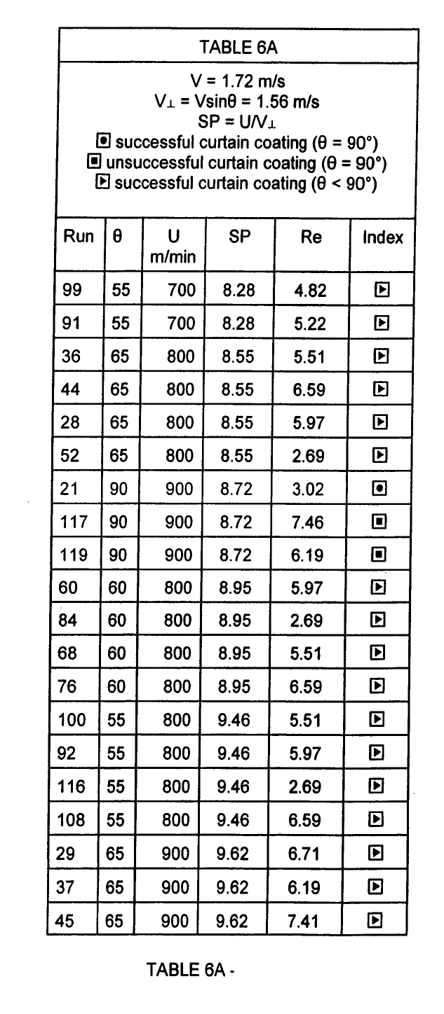

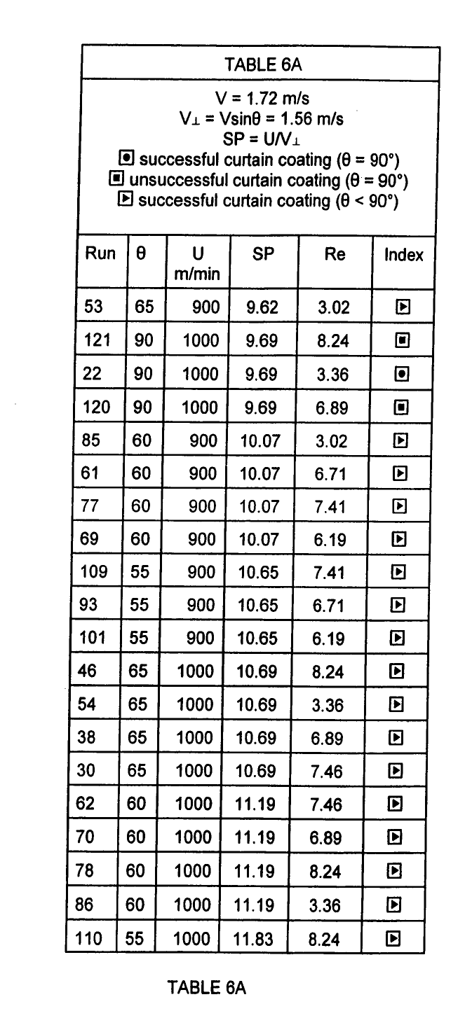

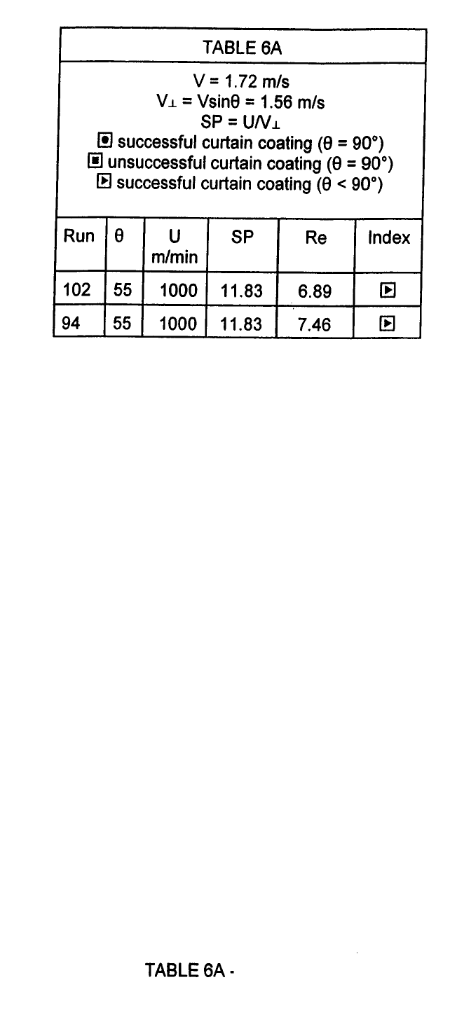

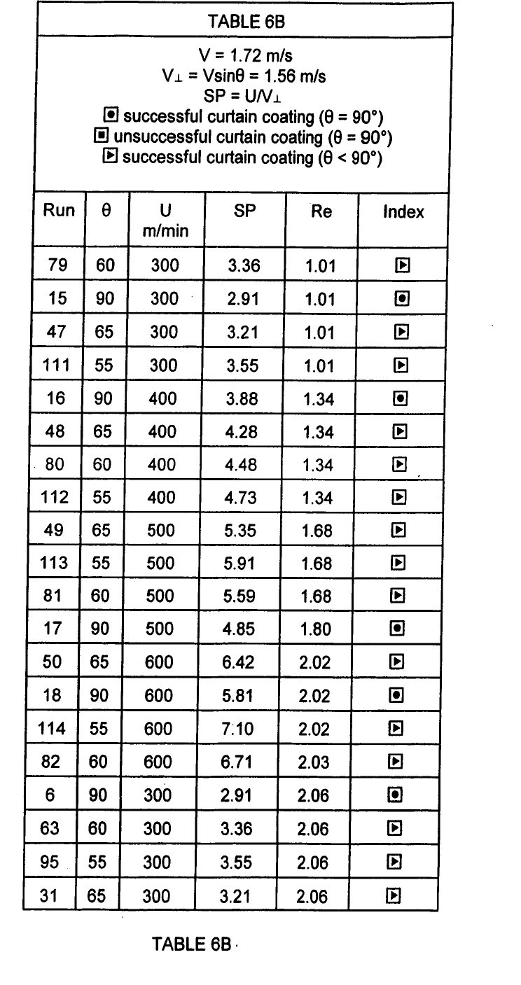

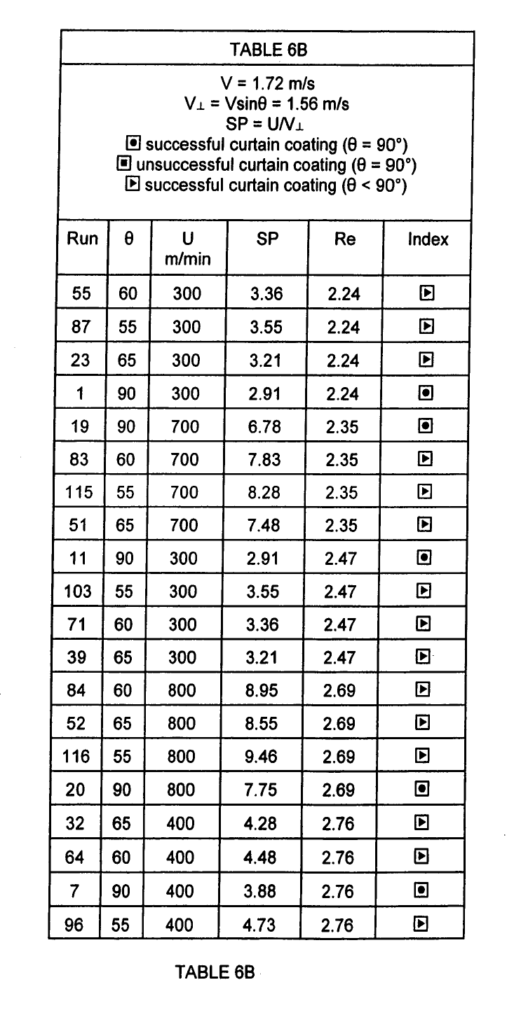

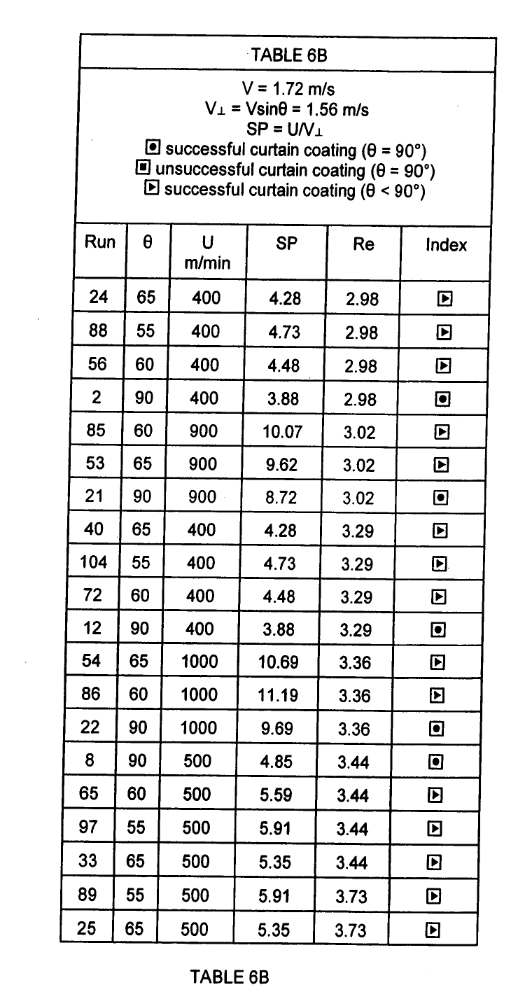

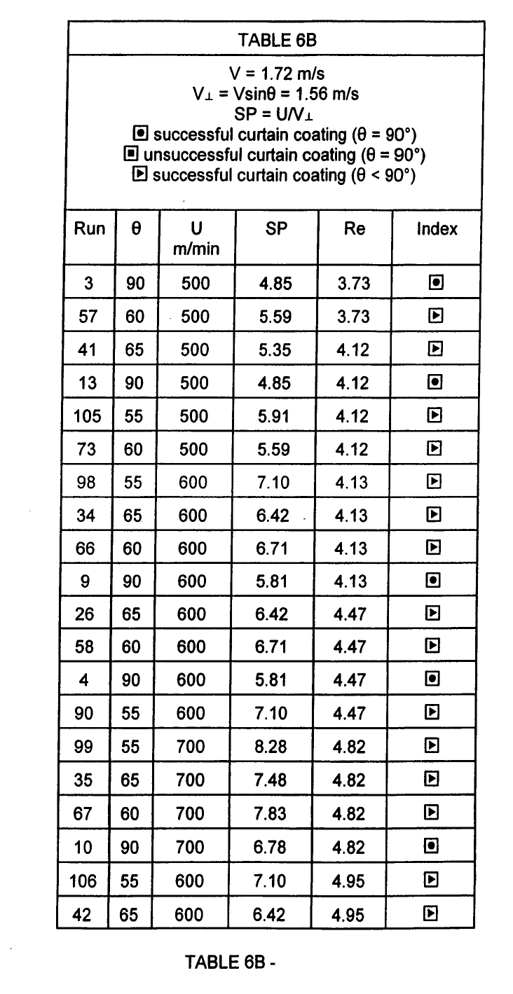

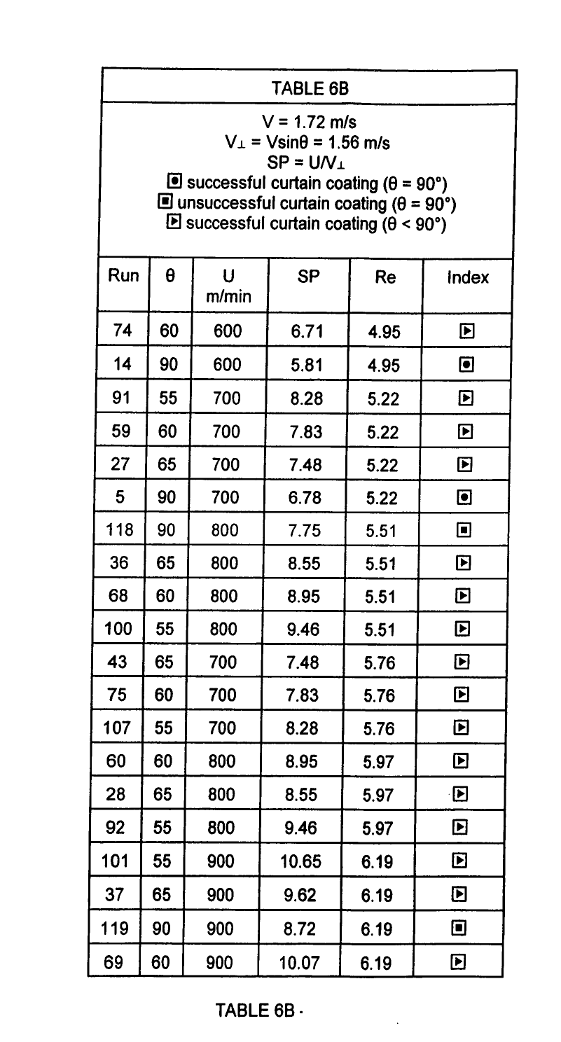

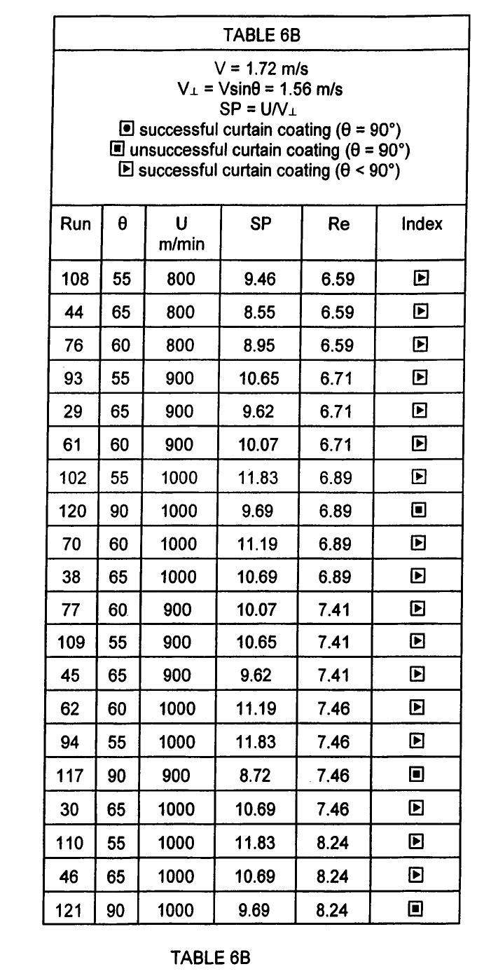

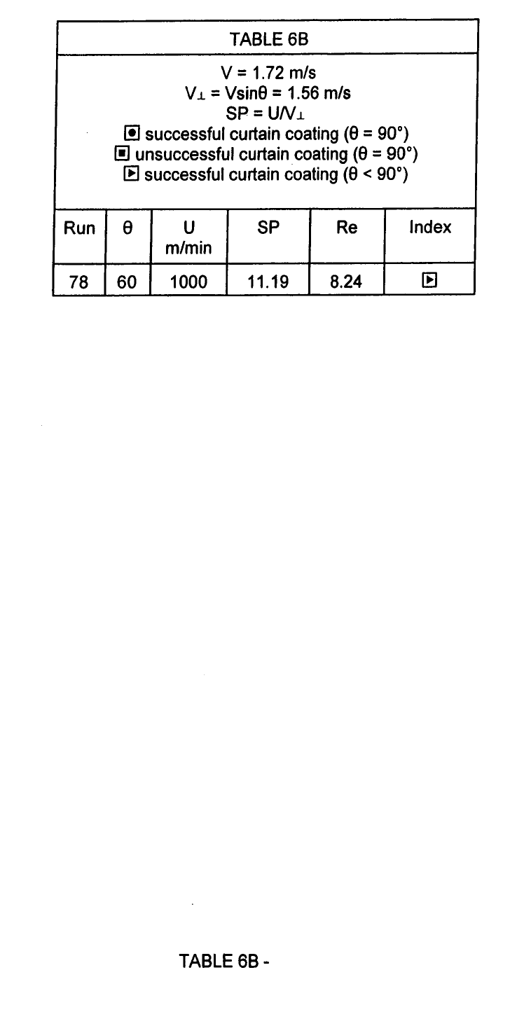

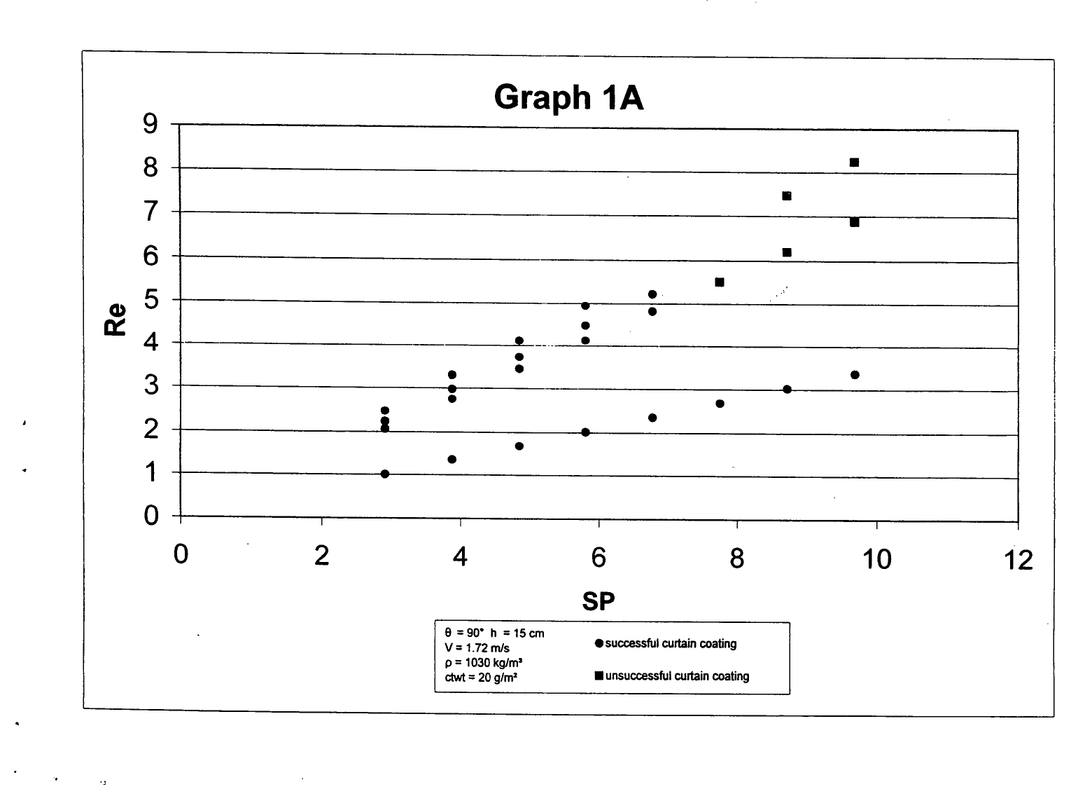

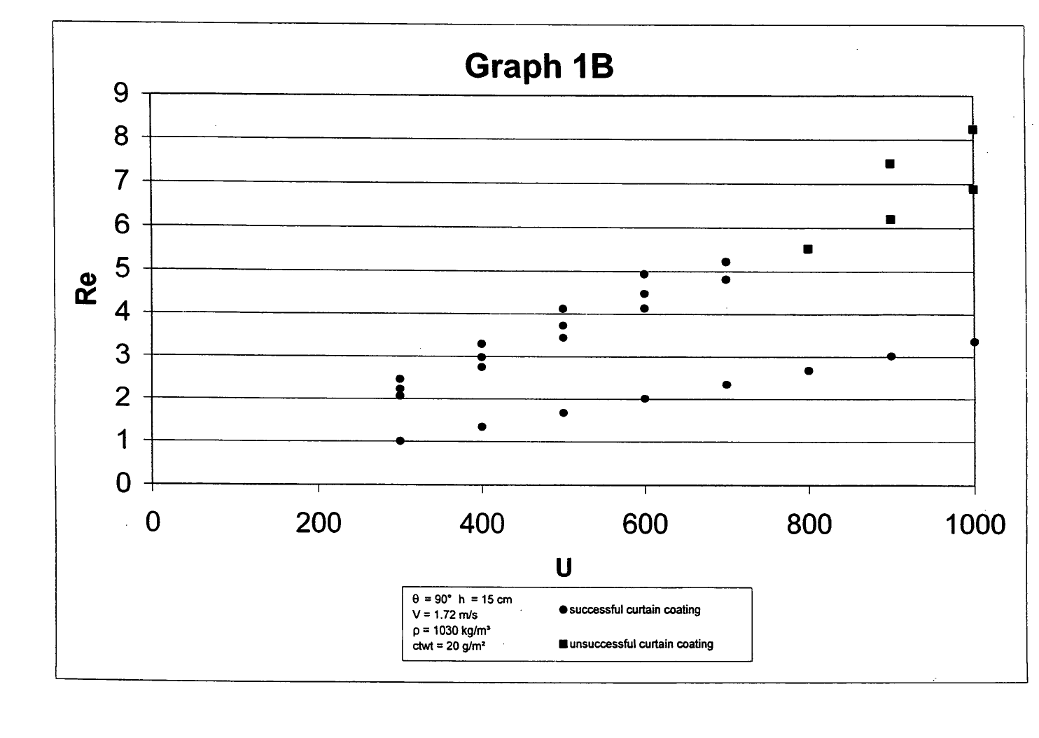

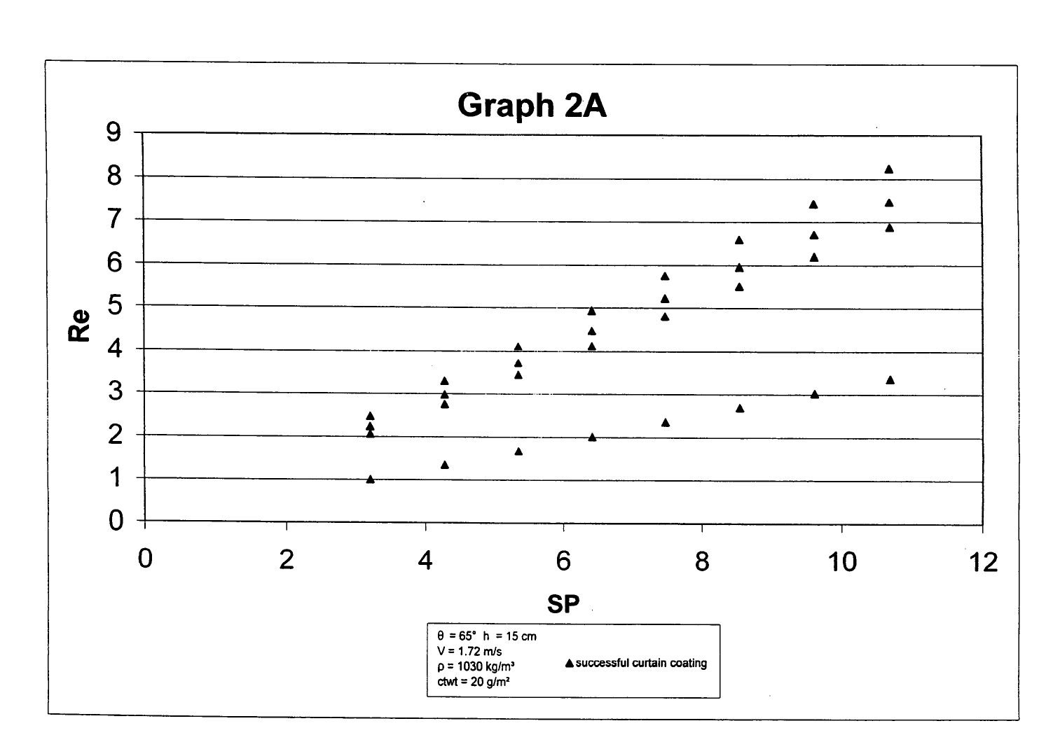

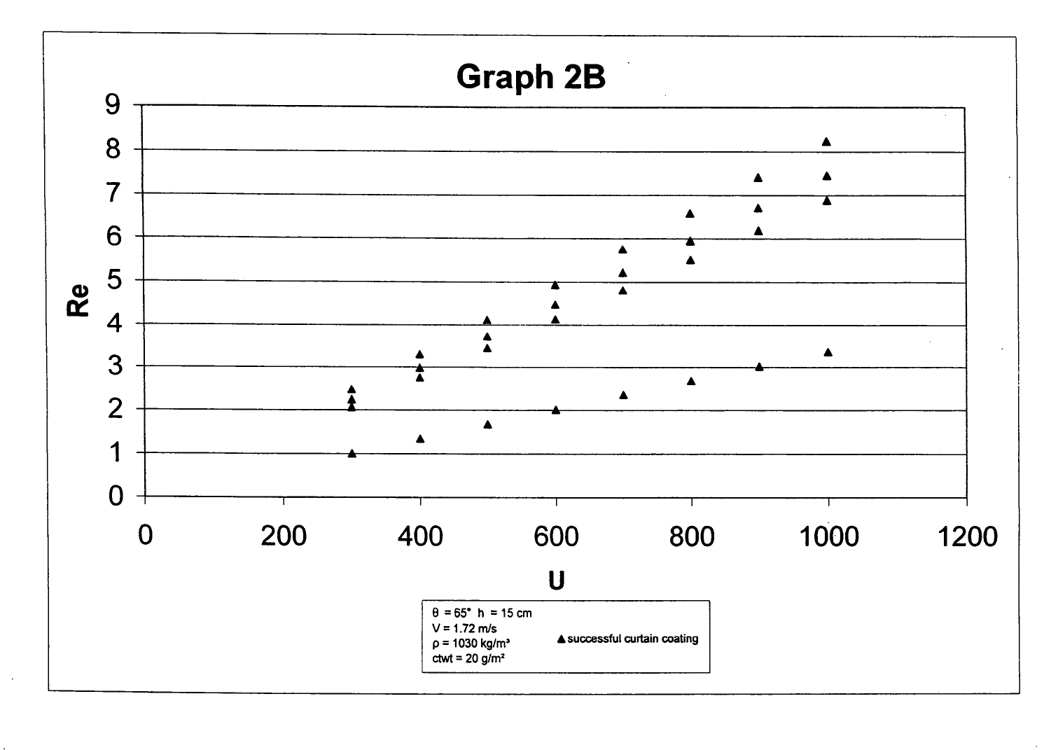

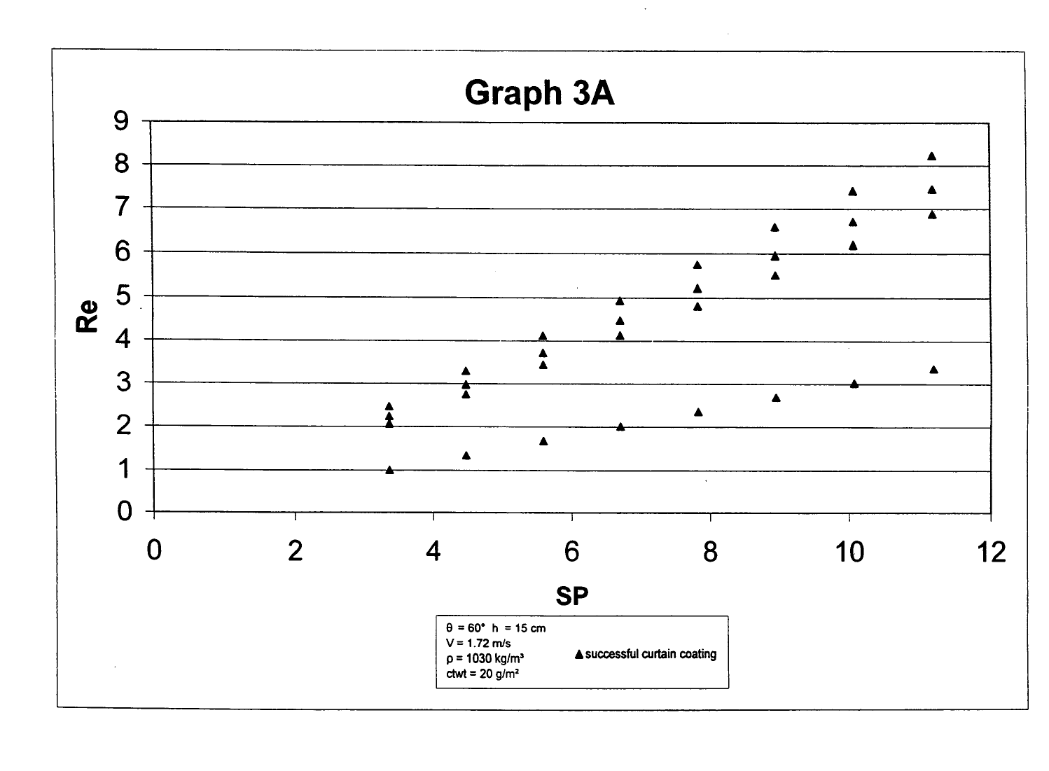

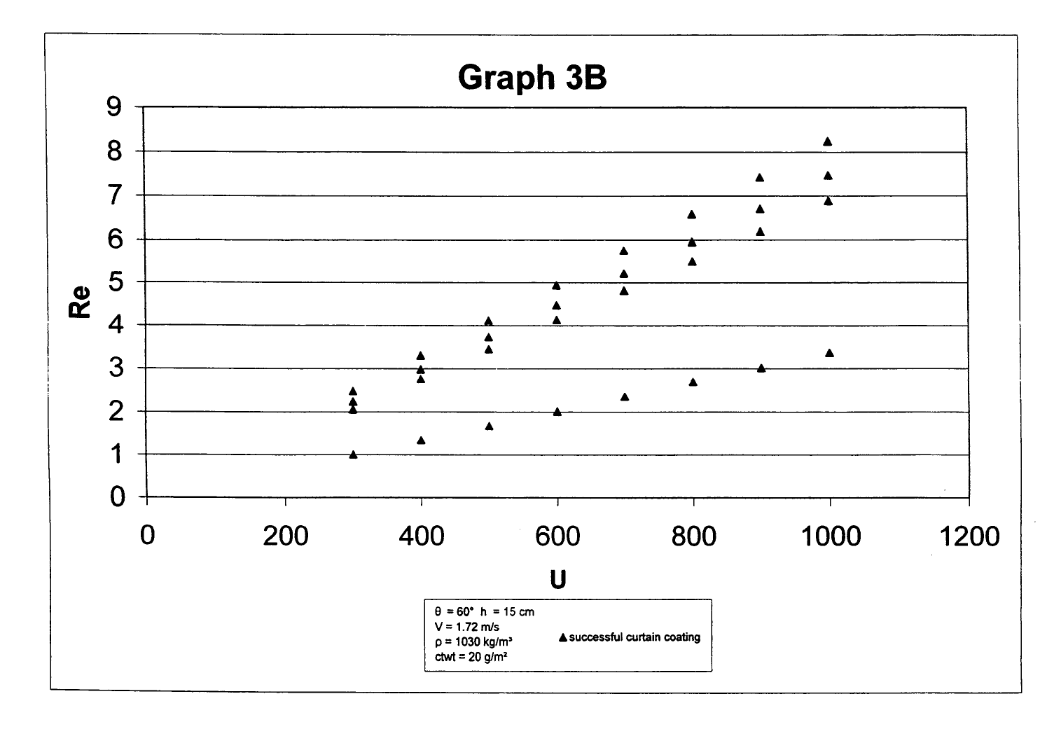

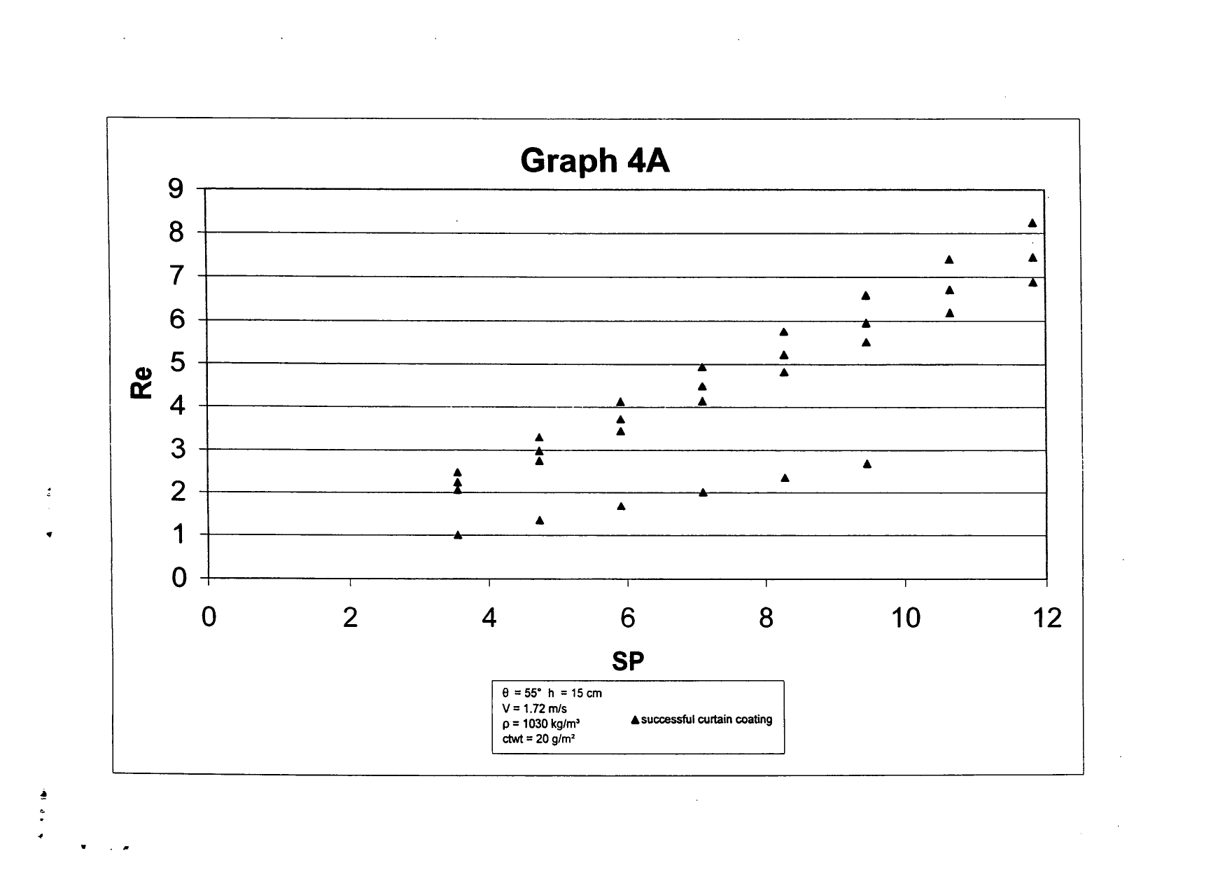

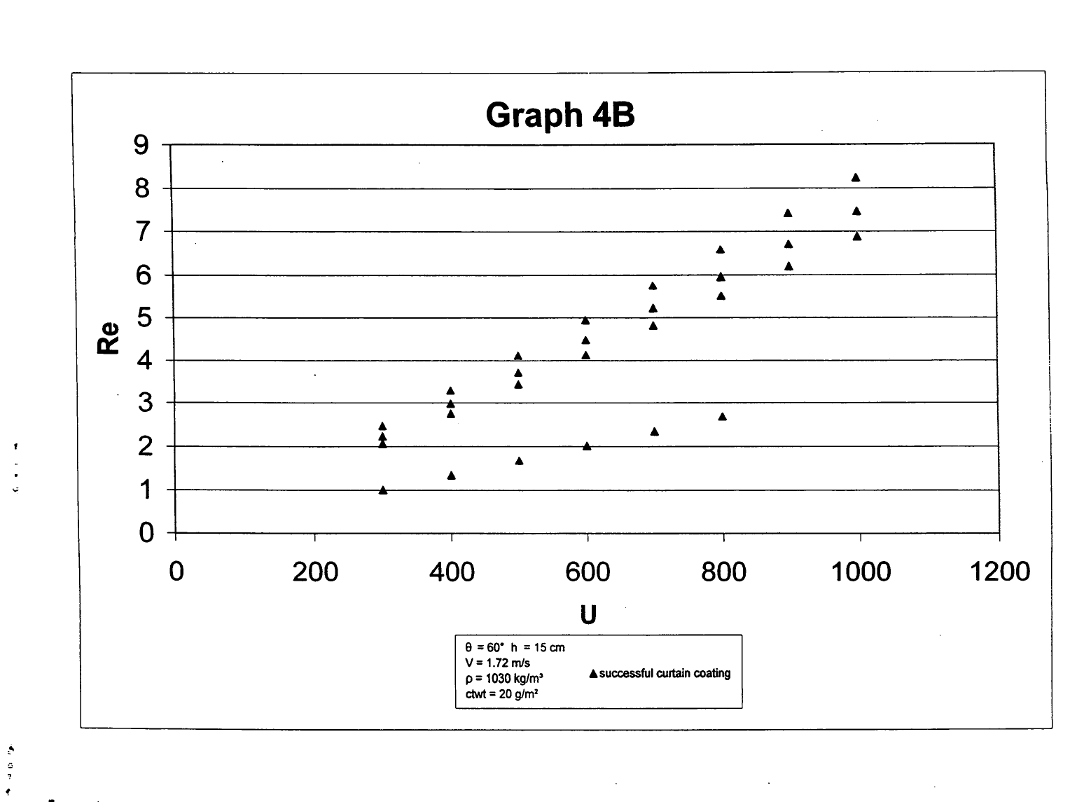

Some component modifications to the system 10 may be necessary to accommodate curtain coating operations with acute impingement angles (θ). For example, when the impingement angle (θ) is equal to 90° (see FIGS. 1A and 1B), edge guides 40 with a substantially horizontal bottom edge 42 will provide the best fit to the impingement zone 14. (See FIG. 7A.) However, when the impingement angle (θ) is less than 90° (see FIGS. 4A and 4B), edge guides 40 with a slanted bottom edge 42 will provide the best fit to the impingement zone 14. (See FIG. 7B.) The slant angle a of the edge guide 40 can approximate the compliment of the impingement angle (θ) (e.g., α=90−θ.) The vacuum assembly 50 may need to be rotatably mounted relative to an arm 52 to allow the head of the vacuum box 54 to be positioned just upstream of the impingement zone 14 (see FIG. 8) and/or the catch pan (not shown) may have to be moved to provide sufficient clearance for the edge guides 40.

Some component modifications to the system 10 may be necessary to accommodate the high flow rates possible with the present invention. For example, the lip 60 of the die 20 may need to be modified to prevent the curtain 16 from having ballistic and/or anti-ballistic trajectories. The lip 60 includes a top surface 62, which is positioned parallel with the slide of the die 20, and a front surface 64, over which the liquid coating flows to form the top curtain 16. With low curtain flows rates, the front surface 64 slants inward relative to the top surface 62. (FIG. 8A.) With high curtain flow rates, the front surface 64 may need to be shifted outward so that it is positioned substantially perpendicular with the top surface 62. (FIG. 8B.)

One may now appreciate that the present invention provides a method for successfully curtain coating a substrate when the impinging curtain has a high force ratio (Re). The present invention makes a high volumetric flow rates (Q) feasible, thereby making a high substrate velocities (U) possible, and thereby best maximizing the productivity of capital-investment curtain coating equipment. Although the invention has been shown and described with respect to certain preferred embodiments, it is evident that equivalent and obvious alterations and modifications will occur to others skilled in the art upon the reading and understanding of this specification. The present invention includes all such alterations and modifications and is limited only by the scope of the following claims.

### GLOSSARY

The coating weight (ctwt) is the weight of the dried coating on the substrate and is expressed in dimensions of mass per area. (e.g., kg/m²).

The density (ρ) is the density of the liquid coating composition and is expressed in dimensions of mass per volume (e.g., kg/m³).

The predetermined uniform coating thickness (t_{∞}) is the thickness (or height) of the liquid coating composition if perfectly applied and is expressed in dimensions of length (e.g., mm).

The final coating thickness (t_{w}) is the actual thickness of the liquid coating on any particular point across the width of the coating and is expressed in dimensions of length (e.g., mm).

The substrate velocity (U) is the velocity of the substrate through the impingement zone and is expressed in dimensions of length per time (e.g., m/min).

The downstream direction (D) is the direction of the substrate as it passes through the impingement zone and is dimensionless.

The impingement velocity (V) is the velocity of the curtain just prior to contacting the substrate in the impingement zone and is expressed in dimensions of length per time (e.g., m/s).

The gravitational acceleration (g) is a constant representing the acceleration caused by gravity and is expressed in length per time-squared (e.g., 9.81 m/s²).

The initial velocity (V₀) is the initial velocity of the curtain at die-lip-detachment and is expressed in dimensions of length per time (e.g., m/s).

The impingement angle (θ) is the angle between a vector representing gravity (i.e., a vertical vector) and a downstream portion of a vector tangential to, or parallel with, the substrate as it passes through the impingement zone and is expressed dimensions of angular units (e.g., degrees).

The horizontal component Uₓ is the horizontal component of the substrate velocity (U) (i.e., Uₓ=U sin θ) and is expressed in dimensions of length per time (e.g., m/min).

The vertical component U_{y} is the vertical component of the substrate velocity (U) (i.e., U_{y}=U cos θ) and is expressed in dimensions of length per time (e.g., m/min.) The parallel impingement component (V_{∥}) is the component of the impingement velocity (V) positioned parallel with the substrate velocity (U) (i.e., V_{∥}=V sin θ) and is expressed in dimensions of length per time (e.g., m/s).

The perpendicular impingement component (V_{⊥}) is the component of the impingement velocity (V) positioned perpendicular with the substrate velocity (U), (i.e., V_{⊥}=V sin θ) and is expressed in dimensions of length per time (e.g., m/s).

The speed ratio (SP) is the ratio of the substrate velocity (U) to the perpendicular impingement component (V_{⊥}) and is dimensionless.

The width (w) is the lateral cross-wise dimension of the curtain and is expressed in dimensions of length (e.g., m).

The height (h) is the vertical dimension of the curtain from die-lip-detachment to the impingement zone and is expressed in dimensions of length (e.g., cm).

The volumetric flow rate per unit width (Q) is the volumetric flow rate of the curtain divided by the width (w) of the curtain and is expressed in dimensions of volume per time and length (e.g., kg/s*m).

The mass flow rate per unit width (ρ*Q) is the product of the volumetric flow rate (Q) and the density (ρ) of the liquid coating composition forming the curtain and is expressed in dimensions of mass per unit time and length (e.g., kg/s*m).

The viscosity (η) is the viscosity of the liquid coating composition within the impingement zone at a shear rate of 10,000 1/s and is expressed in dimensions of mass per length and time (e.g., kg/m*s or Pa*s).

The force ratio or Reynolds' number (Re) is the ratio of the mass flow rate per unit width of the curtain (ρ*Q) to the viscosity (η) of the liquid coating composition and is dimensionless.

1. A curtain coating method for coating a substrate with a coating having a desired coating weight (ctwt) and having a thickness (t_{w}) that varies less than 2% from a predetermined uniform final coating thickness (t_{∞}) over the width(w) of the coating; said method comprising the steps of:
providing a liquid composition having a density (ρ) and a viscosity (η);
conveying a substrate, at a substrate speed (U) greater than about 700 m/min and in a downstream direction (D), through an impingement zone;
forming a free-falling curtain of the liquid coating composition having a mass flow rate per unit width (ρ*Q);
impinging the substrate with the free-falling curtain in the impingement zone at an impingement velocity (V) and at an impingement angle (θ) between about 80° and about 40° measured between a vector representing gravity and a downstream portion of a vector tangential to, or parallel with, the substrate as it passes through the impingement zone;
wherein the providing, conveying, forming and/or impinging steps are performed so that:
a force ratio (Re ), which is the ratio of the mass flow rate per unit width (ρ*Q) to the viscosity (η), is greater than about 5.25; and
a speed ratio (SP), which is the ratio of the substrate speed (U) and a perpendicular impingement component (V_{⊥}) of the impingement velocity (V) positioned perpendicular with the substrate velocity (U), is greater than about 7 and less than about 12.

2. A curtain coating method as set forth in claim 1, wherein the substrate velocity (U) is less than about 800 m/min, the force ratio (Re) is less than about 6.00, and the speed ratio (SP) is between about 7.5 and about 9.5.

3. A curtain coating method as set forth in claim 1, wherein the substrate velocity (U) is about 800 m/min to about 1000 m/min, the force ratio (Re) is between about 6 and about 7, and the speed ratio (SP) is between about 8.0 and about 12.0.

4. A curtain coating method as set forth in claim 1, wherein the substrate velocity (U) is about 900 m/min to about 1000 m/min, the force ratio (Re) is between about 7.00 and about 8.00 and the speed ratio (SP) is between about 9.5 and about 12.0.

5. A curtain coating method as set forth in claim 1, wherein the substrate speed (U) is at least about 1000 m/min, the force ratio (Re) is greater than about 8, and the speed ratio (SP) is between about 10.0 and about 12.0.

6. A curtain coating method as set forth in claim 1, wherein a perpendicular component (V_{⊥}) of the impingement velocity (V), which is the component of the impingement velocity (V) positioned perpendicular with the substrate velocity (U), is between about 1.4 m/s and about 1.6 m/s.

7. A curtain coating method as set forth in claim 1, wherein the parallel component (V_{∥}) of the impingement velocity (V), which is the component of the impingement velocity (V) positioned parallel with the substrate velocity (U), is between about 0.7 m/s and about 1.0 m/s.

8. A curtain coating method as set forth in claim 1, wherein the density (ρ) of the liquid coating composition is between about 900 kg/m³ and about 1100 kg/m³ and the viscosity (η) of the liquid coating composition is between about 0.040 Pa*s and about 0.160 Pa*s.

9. A curtain coating method as set forth in claim 8, wherein the curtain has a volumetric flow rate per unit width (Q) between about 0.000189 m³/(s*m) and about 0.00107 m³/(s*m).

10. A curtain coating method as set forth in claim 9, wherein the liquid coating composition is an adhesive coating.

11. A curtain coating method as set forth in claim 1, wherein the density (ρ) of the liquid coating composition is between about 900 kg/m³ and about 1100 kg/m³ and the viscosity (η) of the liquid coating composition is between about 0.005 Pa*s and about 0.015 Pa*s.

12. A curtain coating method as set forth in claim 11, wherein the curtain has a width (w) and a volumetric flow rate per unit width (Q) between about 0.000024 m³/(s*m) and about 0.000100 m³/(s*m).

13. A curtain coating method as set forth in claim 12, wherein the liquid coating composition is a release coating.

14. A curtain coating system for performing the curtain coating method of claim 1, wherein the system comprises a conveyor that conveys the substrate in the downstream direction through the impingement zone, and a die from which the liquid coating composition flows to form the curtain.

15. A curtain coating system as set forth in claim 14, wherein the conveyor comprises a back-up roller and wherein the impingement zone is offset in the downstream direction from a top-dead-center of the back-up roller.

16. A curtain coating system as set forth in claim 14, wherein the conveyor comprises a pair of conveying rollers vertically offset in the downstream direction (D) and wherein the impingement zone is positioned between the rollers.

17. A curtain coating system as set forth in claim 14, further comprising edges guides with bottom surfaces slanted in a downward direction at a slant angle (α) approximately equal to the compliment of the impingement angle (θ).

18. A curtain coating system as set forth in claim 14, further comprising a vacuum assembly having a rotatably mounted vacuum box.

19. A curtain coating system as set forth in claim 14, wherein the die comprises a die lip including a top surface which is positioned parallel with a slide surface and a front surface over which the liquid coating composition flows to form the curtain, and wherein the front surface is positioned substantially perpendicular to the top surface.

20. A curtain coating system comprising:
a substrate,
a liquid coating composition having a density (ρ) between about 900 kg/m³ and about 1100 kg/m³ and a viscosity (η) between about 0.040 Pa*s and about 0.160 Pa*s or between about 0.005 Pa*s and about 0.015 Pa*s,
an impingement zone,
a conveyor conveying the substrate at a substrate speed (U) greater than about 700 m/min and in a downstream direction (D) through the impingement zone, and
a die assembly forming a free-falling curtain of the liquid coating composition, the curtain having a width (w) and a mass flow rate per unit width (ρ*Q);
wherein the conveyor, and the die assembly are positioned and/or operated, so that:
the curtain impinges the substrate in the impingement zone at an impingement angle (θ) between 80° and 40°, the impingement angle (θ) being the angle between a vector representing gravity and a downstream portion of a vector tangential to, or parallel with, the substrate as it passes through the impingement zone;
the curtain coats the substrate with a coating having a thickness (t_{w}) which varies less than 2% from a predetermined uniform final coating thickness (t_{∞}) over the width(w) of the coating;
the force ratio (Re) of the mass flow rate per unit width (ρ*Q) of the liquid coating composition to the viscosity (η) of the liquid coating composition is greater than 5.25;
the perpendicular component (V_{⊥}) of the impingement velocity (V) is between about 1.4 m/s and 1.6 m/s, the perpendicular component (V_{⊥}) being the component of the impingement velocity (V) positioned perpendicular with the substrate velocity (U), is between 1.4 m/s and 1.6 m/s; and
the speed ratio (SP), of the substrate speed (U) and the perpendicular impingement component (V_{⊥}) is greater than 7 and less than 12.
